(19) United States
(12) Patent Application Publication
(10) Pub. No.: US 2026/0052496 A1
(43) Pub. Date: Feb. 19, 2026

(54) TIMING ALIGNMENT IN DUPLEX

(71) Applicant: InterDigital Patent Holdings, Inc., Wilmington, DE (US)

(72) Inventors: Nazli Khan Beigi, Longueuil (CA); Jonghyun Park, Syosset, NY (US); Moon-il Lee, Melville, NY (US); Paul Marinier, Brossard (CA)

(73) Assignee: InterDigital Patent Holdings, Inc., Wilmington, DE (US)

(21) Appl. No.: 19/101,196

(22) PCT Filed: Aug. 3, 2023
(86) PCT No.: PCT/US2023/029367

§ 371 Date: Feb. 4, 2025

Related U.S. Application Data
(60) Provisional application No. 63/395,141, filed on Aug. 4, 2022.
(60) Provisional application No. 63/465,422, filed on May 10, 2023.

(51) Int. Cl. H04W 56/00; H04L 5/14; H04W 72/0446; H04W 72/1268

(52) U.S. Cl. CPC H04W 56/0045; H04L 5/14; H04W 72/0446; H04W 72/1268

(57) ABSTRACT

Systems, methods, and instrumentalities are disclosed herein associated with timing alignment in duplex. A wireless transmit/receive unit (WTRU) may be configured to determine a guard time period. The WTRU may receive information related to a grant allocation. The grant allocation may begin at a time associated with a number of starting symbol(s) within a subband. The WTRU may determine that the time associated with the number of starting symbol(s) is within the guard time period. The WTRU may calculate the difference between the time associated with the number of starting symbols and the start time of the guard time period. The WTRU may determine to puncture a part of the transmission that uses the grant allocation based on the size of the difference between the time associated with number of starting symbol(s) and the start time of the guard time period.

### CROSS-REFERENCE TO RELATED APPLICATIONS

This application claims the benefit of Provisional U.S. Patent Application No. 63/395,141, filed Aug. 4, 2022 and Provisional U.S. Patent Application No. 63/465,422, filed May 10, 2023, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Systems, methods, and instrumentalities are disclosed herein associated with timing alignment in duplex. A wireless transmit/receive unit (WTRU) may be configured receive one or more timing advance (TA) command(s) (e.g., via radio resource control (RRC), medium access control control element (MAC-CE), downlink control information (DCI), random access response (RAR) message, etc.). A guard time period (e.g., a number of guard time symbols (e.g., N)) may be determined from the timing advance (TA) command(s) to accommodate the TA. The WTRU may receive information related to (e.g., or may be scheduled with) a grant allocation (e.g., an uplink (UL) grant allocation, via RRC, MAC-CE, DCI). The grant allocation may begin at a time associated with a number of starting symbol(s) (e.g., N′) within a subband (e.g., a subband non-overlapping full duplex (SBFD) time unit (e.g., symbol, slot, frame, subframe etc.)). The WTRU may determine that the number of starting symbol(s) (e.g., N′) is less than the number of guard symbols (e.g., N)) (e.g., that the time associated with the number of starting symbol(s) is within the guard time period).

The WTRU may calculate the difference between the time associated with the number of starting symbols and the start time of the guard time period (e.g., the number of overriding, overlapping, and/or discrepancy symbols (e.g., delta_N=N−N′)). The WTRU may determine to truncate, skip, or puncture a part of the transmission (e.g., the UL transmission) that uses the grant allocation (e.g., the delta_N) based on the size of the difference between the time associated with number of starting symbol(s) and the start time of the guard time period (e.g., delta_N) (e.g., and based on the transmission not overlapping with a higher priority signal). The WTRU may send the transmission based on the determination of whether to truncate, skip, or puncture the part of the transmission that uses the grant allocation (e.g., the delta_N).

In examples, the WTRU may be configured to puncture the part of the transmission that uses the grant allocation based on the size of the difference between the time and the start of the guard time period (e.g., delta_N) being greater than a threshold. In examples, the WTRU may be configured to transmit the transmission in all symbols associated with the grant allocation at least based on the size of the difference between the time and the start of the guard time period (e.g., delta_N) being less than a threshold. The transmission may be an uplink control information (UCI) transmission on a physical uplink shared channel (PUSCH). The skipping, puncturing, or truncating of the part of the UCI transmission may be puncturing a number of coded-modulation symbols for the UCI transmission. The WTRU may be configured to send a report indicating the difference between the time associated with number of starting symbol(s) and the start time of the guard time period (e.g., delta_N).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2, shows an example of incorporating guard time period for timing alignment within uplink (UL) or downlink (DL) subbands (SBs)/slots.

FIG. 3 shows an example of a shorten CP to accommodate guard time period within an uplink (UL) slot in subband non-overlapping full duplex (SBFD) SB.

FIG. 4 shows an example of an SBFD.

FIG. 5 shows an example of conventional time-division duplexing (TDD) and guard time period.

FIG. 6 shows an example of inter-Slot interference due to timing advance in SBFD UL subbands (SBs).

FIG. 7 shows an example of inter-slot interference due to switching time in SBFD UL SBs.

FIG. 8 shows an example of an SBFD.

FIG. 9 shows an example of resource mapping for physical uplink shared channel (PUSCH) transmission(s) (valid S and L combinations).

FIG. 10 illustrates an example of a WTRU handling a guard time period discrepancy in SBFD slots.

FIG. 11 shows an example of a shorten cyclic prefix (CP) to accommodate a guard time period within an UL slot in SBFD SB.

### DETAILED DESCRIPTION

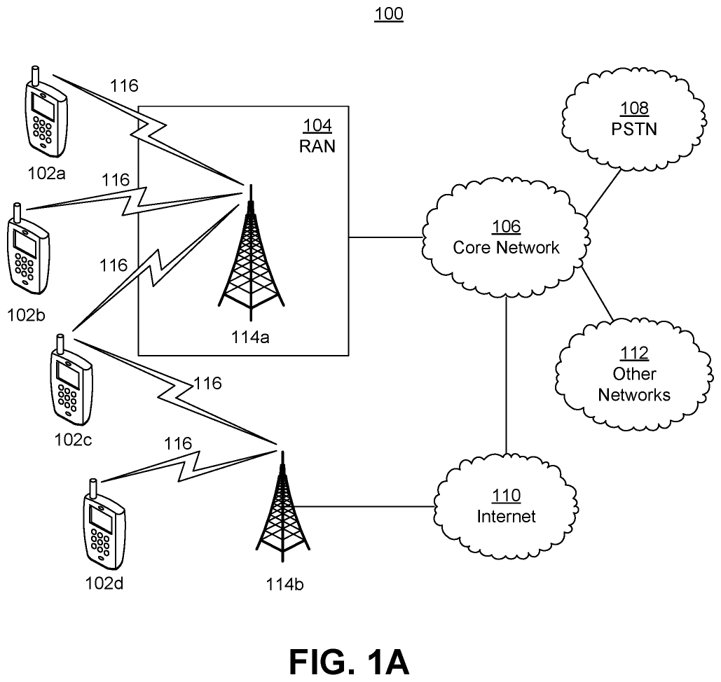

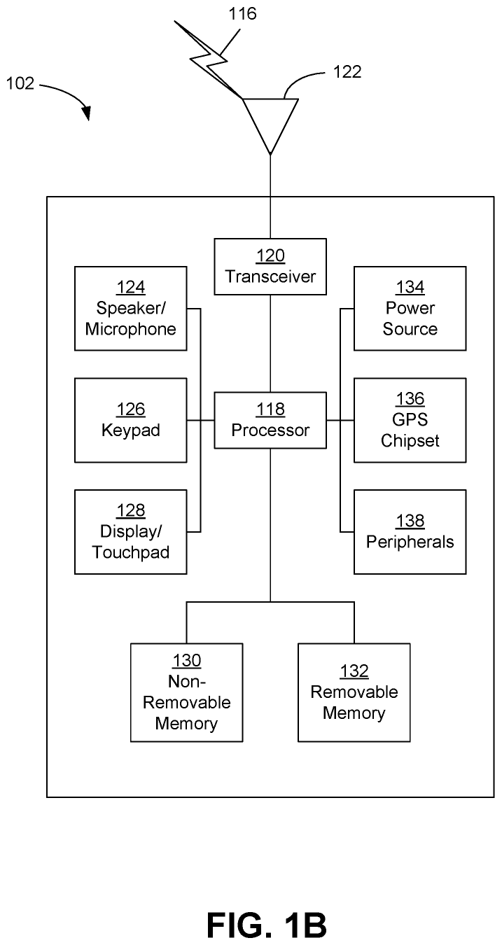

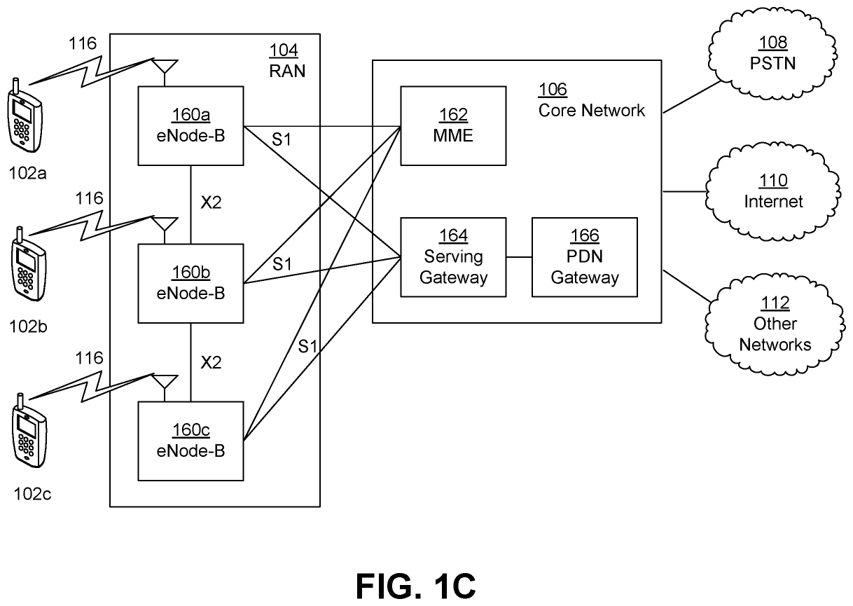

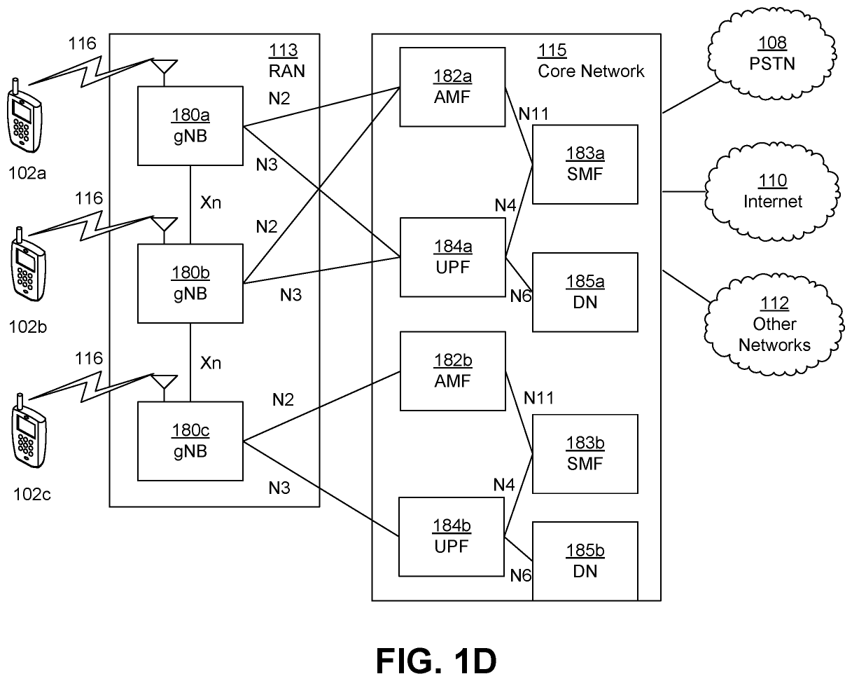

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-PCT/US2023/029367 eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are disclosed herein associated with timing alignment in duplex. A wireless transmit/receive unit (WTRU) may be configured receive one or more timing advance (TA) command(s) (e.g., via radio resource control (RRC), medium access control control element (MAC-CE), downlink control information (DCI), random access response (RAR) message, etc.). A guard time period (e.g., a number of guard time symbols (e.g., N) may be determined from the timing advance (TA) command(s) to accommodate the TA. The WTRU may receive information related to (e.g., or may be scheduled with) a grant allocation (e.g., an uplink (UL) grant allocation, via RRC, MAC-CE, DCI). The grant allocation may begin at a time associated with a number of starting symbol(s) (e.g., N′) within a subband (e.g., a subband non-overlapping full duplex (SBFD) time unit (e.g., symbol, slot, frame, subframe etc.). The WTRU may determine that the number of starting symbol(s) (e.g., N′) is less than the number of guard symbols (e.g., N)) (e.g., that the time associated with the number of starting symbol(s) is within the guard time period).

The WTRU may calculate the difference between the time associated with the number of starting symbols and the start time of the guard time period (e.g., the number of overriding, overlapping, and/or discrepancy symbols (e.g., delta_N=N−N′). The WTRU may determine to truncate, skip, or puncture a part of the transmission (e.g., the UL transmission) that uses the grant allocation (e.g., the delta_N) based on the size of the difference between the time associated with number of starting symbol(s) and the start time of the guard time period (e.g., delta_N) (e.g., and based on the transmission not overlapping with a higher priority signal). The WTRU may send the transmission based on the determination of whether to truncate, skip, or puncture the part of the transmission that uses the grant allocation (e.g., the delta_N).

In examples, the WTRU may be configured to puncture the part of the transmission that uses the grant allocation based on the size of the difference between the time and the start of the guard time period (e.g., delta_N) being greater than a threshold. In examples, the WTRU may be configured to transmit the transmission in all symbols associated with the grant allocation at least based on the size of the difference between the time and the start of the guard time period (e.g., delta_N) being less than a threshold. The transmission may be an uplink control information (UCI) transmission on a physical uplink shared channel (PUSCH). The skipping, puncturing, or truncating of the part of the UCI transmission may be puncturing a number of coded-modulation symbols for the UCI transmission. The WTRU may be configured to send a report indicating the difference between the time associated with number of starting symbol(s) and the start time of the guard time period (e.g., delta_N).

Examples of incorporating a timing alignment guard time period within uplink (UL) or downlink (DL) slots in SBFD subbands (SBs) are provided herein. Examples herein may include one or more of the following related to incorporating the timing alignment guard time period: modes of operation; priority and triggering events; PUSCH types; shorten cyclic prefix (CP) technique; fall back schemes; or forming the codeword for data and control multiplexing, which may include determining used resource elements (REs) in the PUSCH piggybacking the uplink control information (UCI).

In examples, a WTRU may receive information indicating one or more timing advance (e.g., timing alignment) commands associated with a DL slot and a UL slot in SBFD. Based on the one or more TACs, the WTRU may determine a timing advance (TA). The WTRU may determine a priority level for a DL symbol associated with the DL slot and a priority level for a UL symbol associated with the UL slot. The WTRU may determine a mode of operation based on at least one of the determined TA, the determined priority for the DL symbol, or the determined priority for the UL symbol.

Examples of PUSCH mapping types are provided. Examples of switching PUSCH mapping settings are provided. Examples of a PUSCH type A overlapping with a delta_N>threshold are provided. Examples of a PUSCH type B overlapping with a delta_N>threshold are provided. Examples of reporting delta_N in PUSCH are provided.

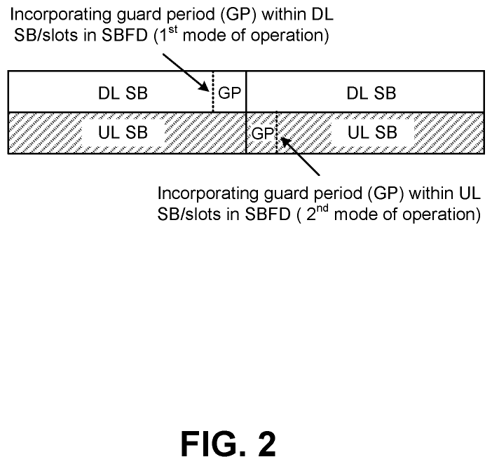

Examples of incorporating a timing alignment guard time period within UL and/or DL slots in SBFD SBs, (e.g., as shown in FIG. 2) are provided herein. A WTRU may receive one or more TAC(s) from a gNB. The TAC(s) may include guard time period configurations, for example, an indication on whether gNB allows for DL symbol(s) (e.g., previous DL symbol(s) to be used as guard time period and/or a priority level for DL and UL SB/slots. The WTRU may determine the timing advance (TA (e.g., TA(new) based on the received TACs. The WTRU may determine the number of symbols (N) that are used to accommodate a TA based on the determined TA(new). In examples, the WTRU may determine the timing alignment discrepancy (e.g., delta_N) (e.g., due to timing advance and/or switching time) based on the difference between the configured timing (e.g., from gNB) and the determined timing (e.g., at the WTRU). The WTRU may determine the priority level for DL symbol(s) vs. UL symbol(s) in respective SB/slots (e.g., explicitly based on indication from the gNB or implicitly based on scheduled UL and/or DL).

The WTRU may determine the mode of operation based on at least one of a configuration, a determined TA, a delta_N, or a determined priority level for DL vs. UL. The WTRU may expect to be configured with the first mode of operation in operations that the TA is already implemented with (e.g., via gNB implementation and gNB scheduling techniques). If the WTRU determines a discrepancy (e.g., delta_N), the WTRU may select from remaining modes of operation. In examples, if the WTRU determines that the TA configured by gNB is not sufficient, the WTRU may select from modes 2 to 5. The WTRU may apply the determined mode to accommodate the time/symbol discrepancy accordingly.

A first mode of operation may include using and/or puncturing last symbol(s) (e.g., delta_N) in the preceding DL SB/slot. The WTRU may expect to be configured with this mode of operation in the majority of operations (e.g., via gNB implementation and gNB scheduling techniques). A second mode of operation may include using and/or puncturing first symbol(s) (e.g., delta_N) in respective UL SB/slot(s). The WTRU may determine or be configured with (e.g., explicitly or implicitly) the events that trigger this mode. A third mode of operation may include a shorten CP technique in respective UL SB/slot(s). CP lengths (e.g., all CP lengths) within the UL SB/slot may be reduced (e.g., based on a configured limit). The WTRU may determine to use the third mode if the TA length is shorter than a configured time. In examples, the WTRU may use cyclic suffix in the last symbol of the preceding DL SB/slot in addition to CP in the first symbol of the UL SB/slot. The fourth mode of operation include fall-back to UL-only or flexible slots. The WTRU may determine that considered modes of operation lead to dropping the UL/DL SB. In examples, if TA length is shorter than a configured time window, the WTRU may expect back-to-back UL/DL slots in SBFD SBs. Otherwise, the WTRU may expect one or more dropped slots. The WTRU may send a request to gNB to be scheduled in genuine UL-only or flexible slots. For the first and second modes of operation, the WTRU may determine a rate-matching strategy (e.g., shortening and/or puncturing) based on determined parameters (e.g., number of affected symbols).

The WTRU may report the determined parameters, including mode of operation, discrepancy time/number of affected symbols (e.g., delta_N), and/or rate matching strategy. In examples, the WTRU may send a TAC-ACK including the determined parameters. A single flag may indicate one or more of the following: the timing is fine (e.g., if the flag is 0); delta_N more symbols are needed (e.g., if the flag is 1); the timing is not fine and the gNB needs to give more time to receive discrepancies (e.g., if the flag is 1). A physical uplink control channel (PUCCH) Tx (e.g., signal reference (SR) or channel state information (CSI) reporting type may be used to report the determined parameters. A UL MAC-CE via PUSCH may be used to report the determined parameters. The WTRU may receive a confirmation and/or an update on the reported parameters from the gNB. In examples, the gNB may not change anything, change grant to UL-only, etc.

FIG. 2 illustrates an example of incorporating a guard time period for timing alignment within UL or DL SBs/slots. Determining a priority in choosing modes of operation may be based on triggering events. A WTRU may dynamically determine the UL vs. DL priority to select between first and second modes of operation. The first mode of operation may include using and/or puncturing last symbol(s) (e.g., delta_N) in the preceding DL SB/slot. The WTRU may expect to select this mode (e.g., except if the WTRU receives an indication from the gNB to not allow using the preceding DL SB/slots). The WTRU may determine and/or receive the rate matching scheme (e.g., shortening, puncturing, etc.) employed in the preceding DL SB/slot. The second mode of operation may include using and/or puncturing first symbol(s) (e.g., delta_N) in respective SB/slot(s). The WTRU may be configured and/or may determine the events that may trigger this mode. The WTRU may determine the rate matching scheme (e.g., shortening, puncturing, etc.) based on triggering events.

The WTRU may determine and/or identify triggering events and priorities based on implicit and explicit indications. The WTRU may determine the rate matching scheme (e.g., shortening, puncturing, etc.) accordingly. The explicit indication by the gNB may include a DCI 2_x (e.g., similar to uplink grant cancellation). The explicit indication may deprioritize or prioritize a UL grant that translates to using a first or second mode of operation, respectively. The explicit indication may include rate matching schemes (e.g., shortening, puncturing, etc.). Based on a recent (e.g., most recent) grant, if a UL grant is received first (e.g., indicating UL has higher priority than DL such as back-to-back Rx/Tx is possible) and if a DL grant is scheduled that may collide with the previous UL grant (e.g., back-to-back Rx/Tx not possible), the recent DL grant may implicitly be considered to be a higher priority. In such a case, the WTRU may determine to use a second mode of operation and perform puncturing techniques in respective UL SB/slot(s). Based on scheduled UL slot/symbols, if a UL is scheduled in a time window shorter than a configured first timer (e.g., before gNB receives WTRU's TAC-ACK), the WTRU may implicitly determine to use the second mode of operation and to puncture the symbol(s) in UL SB/slot accordingly. Based on a UL grant, if the UL grant is based on dynamic scheduling, the WTRU may implicitly determine to use a second mode of operation rather than the 1^{st} mode in SBFD SBs. The WTRU may determine to use puncturing techniques in the respective SB/slots.

Examples of determining PUSCH types incorporating timing alignment guard time periods within UL/DL slots in SBFD SBs are provided herein. A WTRU may dynamically determine the PUSCH type to be used in incorporating timing alignment guard time period within UL/DL slots in SBFD SBs. A first PUSCH type may be a normal PUSCH. The second PUSCH type may include configuration on a second start and duration, where the WTRU may determine where to start sending or how much of the guard time period to be used (e.g., the guard time period length). The guard time period length may be determined at gNB based on reported affected symbols (N). The gNB may use the guard time period considered (e.g., already considered) in a flexible slot. A third PUSCH type may be implemented in the context of PUSCH repetition type B. In such a case, the WTRU that is scheduled with this PUSCH type may decide whether to use repetition or to use the symbols scheduled for repetition to account for the guard time period.

REs (e.g., required REs) in the PUSCH piggybacking the UCI may be determined. A WTRU may determine the number of symbols affected in accounting timing alignment guard time period in respective UL slot in SBFD SB (e.g., N). The WTRU may determine the number of REs for UCI (e.g., HARQ-ACK, CSI part 1, and/or CSI part 2) multiplexed in PUSCH. The WTRU may determine (e.g., additionally determine) the number of REs for the timing alignment guard time period incorporated/multiplexed in PUSCH. The WTRU may calculate the number of coded modulation symbols per layer for UCI and timing alignment guard time period. The WTRU may determine to puncture and/or rate-match the resulting codeword accordingly. For example, the N last symbols in respective SB/slot may be punctured and/or truncated.

Examples of forming the codeword for data and control multiplexing are provided herein. A WTRU may determine data and control multiplexing in codeword formation based on one or more of the following: REs may be mapped corresponding to demodulation reference signal (DMRS) symbols; based on the timing alignment discrepancy (e.g., delta_N and due to timing advance and/or switching time), the resources/SBs may be skipped, dropped, and/or punctured corresponding to the last (e.g., delta_N) affected symbols within a respective slot (e.g., puncturing DMRS bits may be avoided); coded HARQ-ACK bits may be reserved and/or mapped; the coded CSI report (e.g., as described herein) may be mapped; the coded UL-SCH bits may be mapped; or the codeword may be formed.

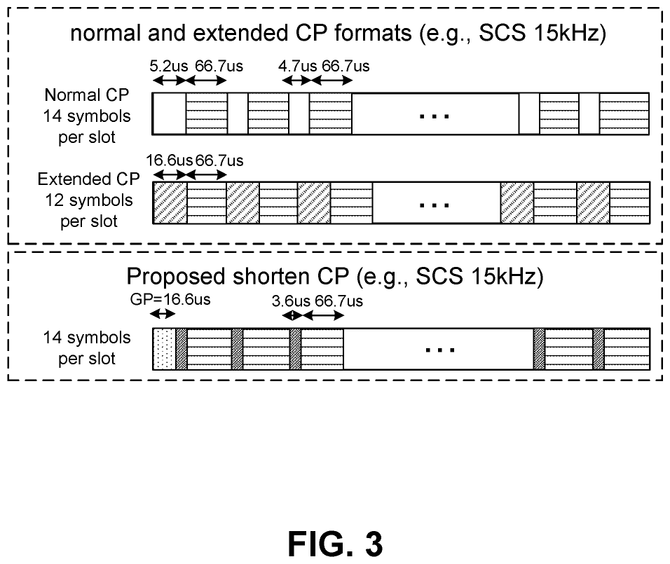

FIG. 3 illustrates an example of a shorten CP to accommodate a guard time period within a UL slot in SBFD SB. The CP may be shortened to accommodate the timing alignment in a resulted gap. A WTRU may receive one or more TACs. The TAC may include configurations to account for timing advance in SBFD. For example, the configuration may include a timing advance threshold (e.g., TA_max) indicating the maximum timing advance for which shorten CP may be used. For example, the configuration may include one or more CP length limits (e.g., CP_min) indicating the minimum allowed CP length for the symbols in a UL slot in an SBFD SB (e.g., cell-common or WTRU-specific). The WTRU may determine a TA(new) based on the received TACs. The WTRU may determine to use shorten CP based on the TA(new) for respective UL SB/slot(s) (e.g., if TA(new) is lower than the configured threshold (TA_max)). The WTRU may determine the timing alignment guard time period length at the beginning of a respective UL slot to be equal to TA(new). The WTRU may determine the shortened CP length for the symbols within the slot, accordingly (e.g., as shown in FIG. 3). The WTRU may report to the gNB that the WTRU determined to use shorten CP. The WTRU may (e.g., may additionally) report the timing alignment guard time period length in a respective UL slot in SBFD SB. For example, the WTRU may report GP length using a coefficient with reference to configured TA_max (e.g., ¼, ½, ⅔, and/or 1). Otherwise, in the case where the WTRU determines that shorten CP cannot be used, the WTRU may determine another mode of operation (e.g., as described herein), the WTRU may determine/request to be scheduled to operate in UL only or flexible slots with explicit guard times (e.g., not in SBFD), or the WTRU may report the mode of operation to the gNB.

The WTRU may drop UL/DL grants or switching (e.g., or requesting for switching) from SBFD to genuine UL-only or flexible slots. A WTRU may determine to drop uplink transmission or downlink reception in a SBFD framework due to timing alignment (e.g., time alignment requirements). Based on the WTRU determination, DMRS puncturing may be used. For example, if the codeword formation (e.g., shifting) in a slot in a UL/DL SBFD SB uses (e.g., requires) DMRS puncturing (e.g., due to incorporating the guard time period), the respective slot may be dropped. In examples, based on the WTRU determination, the TA_new may be larger than a first threshold. In examples, the fallback and/or UL/DL dropping may be based on a command from the gNB (e.g., DCI 2_4 and respective cancellation identifier may be used).

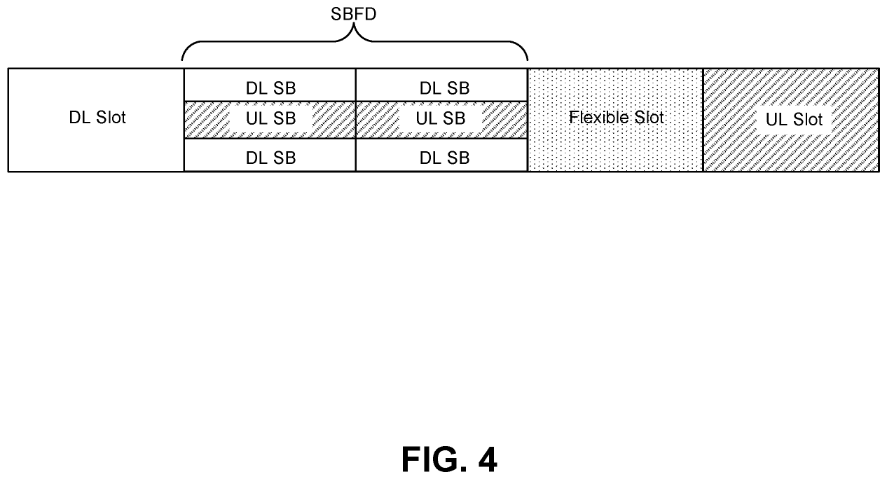

FIG. 4 illustrates an example of an SBFD. Examples of duplex operations may be provided herein. Time-division duplexing (TDD) operations may include enhancing UL coverage, improving capacity, reducing latency, etc. The TDD may be based on splitting the time domain between the uplink and downlink. Allowing full duplex, or SBFD at the gNB within a TDD band may be provided (e.g., as shown in FIG. 4).

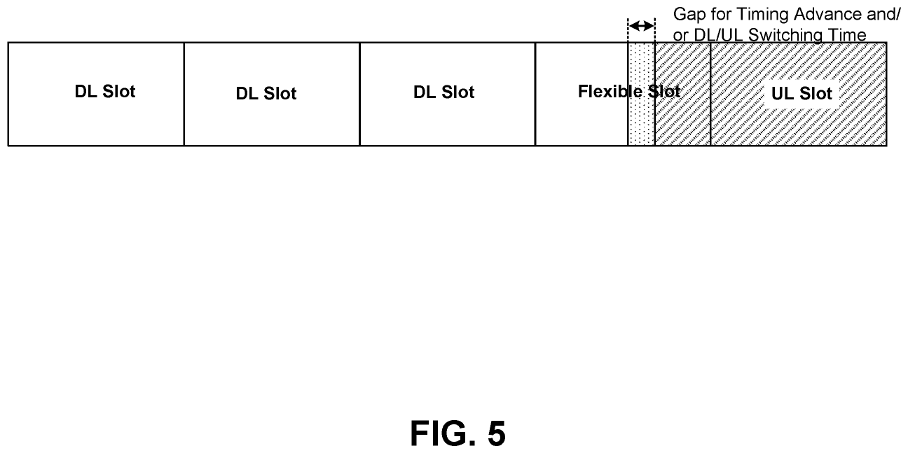

FIG. 5 illustrates an example of a TDD and a guard time period. The realization of SBFD may be subject to challenges in time alignment between UL and DL slots in SBFD. In TDD systems, the UL and DL slots may be considered separately in the time domain. Subsequent slots may be split in DL-only, UL-only, and flexible slots. The symbols in flexible slots may be scheduled to be used as DL or UL based on received configurations. The flexible symbols may be used as guard time period for timing alignment requirements (e.g., DL/UL switching, UL TA, as shown in FIG. 5).

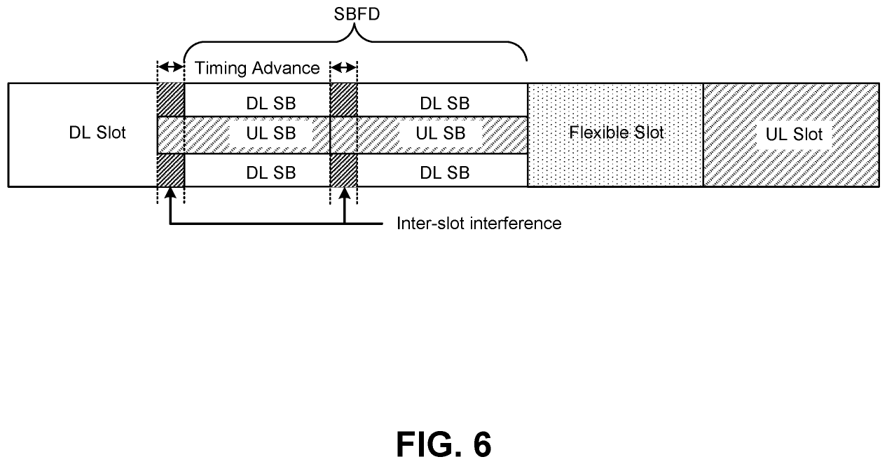

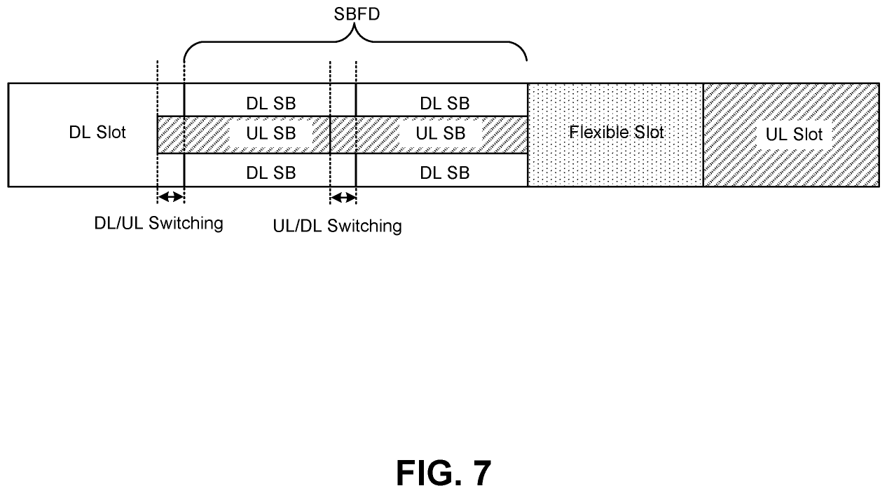

FIG. 6 illustrates an example of inter-slot interference due to timing advance in SBFD UL SBs. FIG. 7 illustrates an example of inter-slot interference due to switching time in SBFD UL SBs. A non-zero timing advance or switching time in SBFD, from the base station point of view, may result in inter-slot interference. As shown in FIGS. 6 and 7, the UL signals in UL SBs and DL signals in DL SBs/slots may be interfered by each other due to timing advance and/or switching time, respectively.

A gNB may track the requested timing advances (e.g., accumulated value). In examples, the WTRU may know the exact value of TA (e.g., which has been accumulated). For a semi-persistent UL grant, the WTRU may be able to dynamically determine the mode of operation (e.g., efficient mode of operation). Examples of how to account (e.g., efficiently account) for timing advance and/or UL/DL switching times in SBFD may be provided herein.

Example techniques on UL/DL timing alignment in SBFD in NR-duplex are provided herein.

Examples of incorporating timing alignment guard time period within UL or DL slots in SBFD SBs are described herein (e.g., including modes of operation and events/priorities for triggering different modes). Examples of rate-matching techniques and PUSCH types for different modes of operation and priority levels are described herein. Examples of codeword forming for data and control multiplexing in PUSCH piggybacking the UCI are provided. Examples of shorten CP and events to trigger fallback to genuine UL-only or flexible slots presented are provided.

A WTRU may transmit or receive a physical channel or reference signal based on at least one spatial domain filter. The term “beam” may be used to refer to a spatial domain filter.

The WTRU may transmit a physical channel and/or signal using the same spatial domain filter as the spatial domain filter used for receiving a reference signal (RS) (e.g., such as CSI-RS) or a synchronization signal (SS) block. The WTRU transmission may be referred to as “target” and the received RS or SS block may be referred to as “reference” or “source”. In such a case, the WTRU may be said to transmit the target physical channel or signal based on a spatial relation with a reference to such RS or SS block.

The WTRU may transmit a first physical channel and/or signal based on the same spatial domain filter as the spatial domain filter used for transmitting a second physical channel and/or signal. The first and second transmissions may be referred to as “target” and “reference” (e.g., or “source”), respectively. In such a case, the WTRU may be said to transmit the first physical channel (e.g., target physical channel) and/or signal based on a spatial relation with a reference to the second physical channel (e.g., reference physical channel) and/or signal.

A spatial relation may be implicit, configured by RRC, or signaled by MAC CE or DCI. For example, a WTRU may implicitly transmit PUSCH and DM-RS of PUSCH based on the same spatial domain filter as an sounding reference signal (SRS) indicated by an SRS resource indicator (SRI) indicated via DCI or configured by RRC. In examples, a spatial relation may be configured by RRC for an SRI or signaled by MAC CE for a PUCCH. The spatial relation may be referred to as a “beam indication”.

The WTRU may receive a first downlink channel (e.g., target downlink channel) and/or signal based on the same spatial domain filter and/or spatial reception parameter as a second downlink channel (e.g., reference downlink channel) and/or signal. For example, such association may exist between a physical channel such as a physical downlink control channel (PDCCH) or a physical downlink shared channel (PDSCH) and its respective DM-RS. If the first and second signals are reference signals, such association may exist if the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may (e.g., may also) be referred to as a “beam indication”.

A TRP may be interchangeably used with one or more of transmission point (TP), reception point (RP), radio remote head (RRH), distributed antenna (DA), base station (BS), a sector (e.g., of a BS), and a cell (e.g., a geographical cell area served by a BS) herein. Multi-TRP may be interchangeably used with one or more of MTRP, M-TRP, and multiple TRPs herein.

The term “subband” and/or “sub-band” may be used to refer to a frequency-domain resource and may be characterized by one or more of the following: a set of resource blocks (RBs); s set of RB sets, (e.g., when a carrier has intra-cell guard bands); a set of interlaced resource blocks; a bandwidth part, or portion thereof; or a carrier, or portion thereof. For example, a subband may be characterized by a starting RB and number of RBs for a set of contiguous RBs within a bandwidth part. A subband may be defined by the value of a frequency-domain resource allocation field and bandwidth part index.

The term “XDD” may be used to refer to a subband-wise duplex (e.g., either UL or DL being used per subband) and may be characterized by one or more of the following: cross division duplex (e.g., subband-wise frequency division duplexing (FDD) within a time-division duplexing (TDD) band); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (e.g., non-overlapped sub-band full-duplex); a full duplex other than a same-frequency (e.g., spectrum sharing and subband-wise-overlapped) full duplex; or an advanced duplex method, e.g., other than TDD or FDD (e.g., pure TDD or FDD).

The term “dynamic (/flexible) TDD” may be used to refer to a TDD system/cell which may dynamically (e.g., and/or flexibly) change/adjust/switch a communication direction (e.g., a downlink, an uplink, a sidelink, etc.) on a time instance (e.g., slot, symbol, subframe, and/or the like). In examples, In a system employing dynamic/flexible TDD, a component carrier (CC) or a bandwidth part (BWP) may have a single type among ‘D’, ‘U’, and ‘F’ on a symbol/slot based on an indication by a group-common (GC)-DCI (e.g., format 2_0) including a slot format indicator (SFI) and/or based on TDD-UL-DL-config-common/dedicated configurations. On a given time instance/slot/symbol, a first gNB (e.g., cell and/or TRP) employing dynamic/flexible TDD may transmit a downlink signal to a first WTRU being communicated/associated with the first gNB based on a first SFI and/or TDD-UL-DL-config configured/indicated by the first gNB and a second gNB (e.g., cell and/or TRP) employing dynamic/flexible TDD may receive an uplink signal transmitted from a second WTRU being communicated/associated with the second gNB based on a second SFI and/or TDD-UL-DL-config configured/indicated by the second gNB. In examples, the first WTRU may determine that the reception of the downlink signal is being interfered by the uplink signal, where the interference caused by the uplink signal may refer to a WTRU-to-WTRU cross-layer interference (CLI).

A WTRU may report a subset of CSI components, where CSI components may correspond to at least a CSI-RS resource indicator (CRI), an SSB resource indicator (SSBRI), an indication of a panel used for reception at the WTRU (e.g., such as a panel identity or group identity), measurements such as L1-RSRP, L1-SINR taken from SSB or CSI-RS (e.g., CRI-RSRP, CRI-SINR, ssb-Index-RSRP, SSB-Index-SINR), and/or other channel state information such as at least rank indicator (RI), channel quality indicator (CQI), precoding matrix indicator (PMI), layer index (LI), etc.

An SSB may be provided. A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, etc.

A WTRU may measure and report the CSI. The CSI for a connection mode (e.g., each connection mode) may include or be configured with one or more of the following. The CSI may include or be configured with CSI report configuration, which may include one or more of the following: CSI report quantity (e.g., CQI, RI, PMI, CRI, LI etc.); CSI report type (e.g., aperiodic, semi persistent, periodic); CSI report codebook configuration (e.g., Type I, Type II, Type II port selection, etc.); or CSI report frequency. The CSI may include or be configured with a CSI-RS resource set, which may include one or more of the following CSI resource settings: NZP-CSI-RS resource for channel measurement; NZP-CSI-RS resource for interference measurement; or CSI-IM resource for interference measurement. The CSI may include or be configured with NZP CSI-RS resources, which may include one or more of the following: NZP CSI-RS resource Idl periodicity and offset; QCL Info and TCI-state; or resource mapping (e.g., number of ports, density, CDM type, etc.).

A WTRU may indicate, determine, and/or be configured with one or more reference signals. The WTRU may monitor, receive, and/or measure one or more parameters based on the respective reference signals. For example, one or more of the following may apply. One or more of the parameters described herein may be included in reference signal(s) measurements. In examples, other parameters may be included.

The parameters may include SS reference signal received power (SS-RSRP). SS-RSRP may be measured based on the synchronization signals (e.g., DMRS in PBCH or SSS). It may be defined as the linear average over the power contribution of the REs that carry the respective synchronization signal. In measuring the RSRP, power scaling for the reference signals may be used (e.g., required). In the case where SS-RSRP is used for L1-RSRP, the measurement may be accomplished based on CSI reference signals in addition to the synchronization signals.

The parameters may include CSI-RSRP. CSI-RSRP may be measured based on the linear average over the power contribution of the REs that carry the respective CSI-RS. The CSI-RSRP measurement may be configured within measurement resources for the configured CSI-RS occasions.

The parameters may include SS signal-to-noise and interference ration (SS-SINR). SS-SINR may be measured based on the synchronization signals (e.g., DMRS in PBCH or SSS). It may be defined as the linear average over the power contribution of the REs that carry the respective synchronization signal divided by the linear average of the noise and interference power contribution. In the case where SS-SINR is used for L1-SINR, the noise and interference power measurement may be accomplished based on resources configured by higher layers.

The parameters may include CSI-SINR. CSI-SINR may be measured based on the linear average over the power contribution of the REs that carry the respective CSI-RS divided by the linear average of the noise and interference power contribution. In the case where CSI-SINR is used for L1-SINR, the noise and interference power measurement may be accomplished based on resources configured by higher layers. Otherwise, the noise and interference power may be measured based on the resources that carry the respective CSI-RS.

The parameters may include received signal strength indicator (RSSI). RSSI may be measured based on the average of the total power contribution in configured orthogonal frequency-division multiplexing (OFDM) symbols and bandwidth. The power contribution may be received from different resources (e.g., co-channel serving and non-serving cells, adjacent channel interference, thermal noise, and/or the like).

The parameters may include cross-Layer interference received signal strength indicator (CLI-RSSI). CLI-RSSI may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, etc.).

The parameters may include sounding reference signals RSRP. SRS-RSRP may be measured based on the linear average over the power contribution of the Res that carry the respective SRS.

A property of a grant or assignment may include one or more of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is type A or type B; whether the grant is a configured grant type 1, type 2 or a dynamic grant; whether the assignment is a dynamic assignment or a semi-persistent scheduling (e.g., configured) assignment; a configured grant index or a semi-persistent assignment index; a periodicity of a configured grant or assignment; a channel access priority class (CAPC); or a parameter (e.g., any parameter) provided in a DCI, by MAC or by RRC for the scheduling the grant or assignment. As described herein, an indication by DCI may include one or more of the following: an explicit indication by a DCI field or by radio network identifier (RNTI) used to mask cyclic redundancy check (CRC) of the PDCCH; or an implicit indication by a property such as DCI format, DCI size, coreset or search space, aggregation level, first resource element of the received DCI (e.g., index of first control channel element), where the mapping between the property and the value may be signaled by RRC or MAC. RS may be interchangeably used with one or more of RS resource, RS resource set, RS port, or RS port group herein. RS may be interchangeably used with one or more of SSB, CSI-RS, SRS, or DM-RS herein. Timing alignment may be interchangeably used with one or more of timing advance, timing adjustment, dynamic changing of Tx/Rx boundary, or switching time herein.

Examples of incorporating a timing alignment guard time period within UL or DL slots in SBFD SBs are provided herein.

Examples of modes of operation and timing advances are provided herein. A timing advance may be defined based on a timing advance (e.g., cell-specific timing advance) offset (e.g., N_{TA offset}) and/or a (WTRU-specific) timing advance (e.g., N_{TA}). The timing advance may reflect into the time for which an uplink slot/frame transmission may take place before the start of the corresponding downlink slot/frame from the serving cell. The timing advance may be determined based on (N_{TA}+N_{TA offset})×T_{c}. The timing advance offset may be a cell-specific time parameter that depends on the duplex mode and/or the frequency range (FR). A WTRU may receive one or more (TACs from a gNB (e.g., via MAC CE) for initiating, increasing, or decreasing the timing advance (e.g., N_{TA}).

In examples, a WTRU may receive a TAC (e.g., via MAC CE) along with a random-access response via an index value (e.g., T_{A}=0,1,2, . . . ,3846) where the timing advance may be determined accordingly (e.g., N_{TA}=T_{A}·16·64/2^{μ}, for SCS of 2^{μ}·15 kHz). In examples, a WTRU may receive a TAC (e.g., via MAC CE) to adjust the existing timing advance (e.g., N_{TA_old}) to a value (e.g., N_{TA_new}) via an index value (e.g., T_{A}=0,1,2, . . . ,63), where the timing advance may be determined accordingly (e.g., N_{TA_new}=N_{TA_old}+(T_{A}−31)·16·64/2^{μ}, for SCS of 2^{μ}·15 kHz).

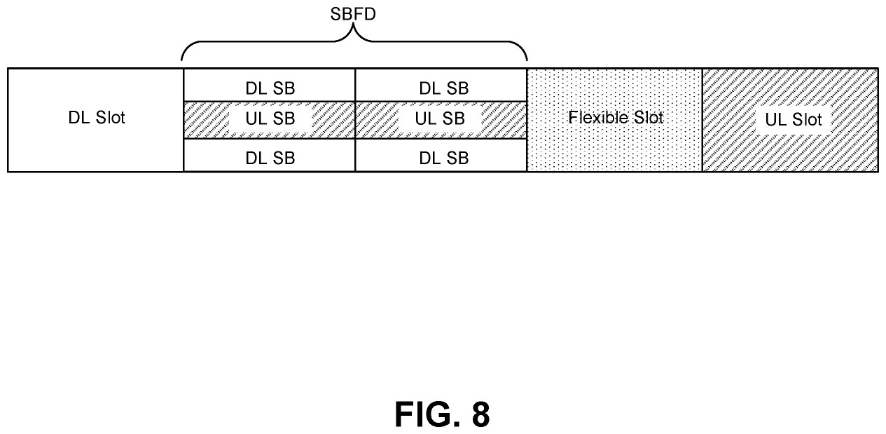

FIG. 8 illustrates an example of an SBFD. An SBFD may be implemented through full duplex transmission at the gNB using an NR RF carrier (e.g., single NR RF carrier) and within a BS channel bandwidth. In examples, the UL transmissions within SBFD may take place in the UL subbands (e.g., aligned with the carrier's center frequency), whereas the DL transmissions within SBFD may take place in the DL subbands (e.g., at the higher and lower frequencies of the carrier's bandwidth), as shown in FIG. 8. As such, in a slot with SBFD, the gNB may schedule UL and DL resources to WTRUs within UL and DL non-overlapping subbands, respectively.

In a slot with SBFD, if a WTRU is scheduled with UL resources in UL subbands, the WTRU may account (e.g., need to account) for respective configured timing advance (e.g., configured via timing advance offset and/or TACs). Otherwise, considering the timing advance for UL transmission in respective SBFD UL subbands may cause inter-slot (e.g., inter-WTRU) interference.

In examples, if a WTRU is scheduled with successive (e.g., back-to-back) UL and DL resources in slots with SBFD, the WTRU may consider (e.g., need to consider) Tx-Rx and/or Rx-Tx switching times. Otherwise, considering the Tx-Rx and/or Rx-Tx switching times in slots with SBFD may cause inter-slot interference for respective WTRU. A WTRU may determine (e.g., need to determine) the mode of operation (e.g., efficient mode of operation) based on triggering events and scheduled resources to avoid abovementioned inter-slot interferences.

Examples of determining discrepancies between configured timing (e.g., at gNB) and determining switching times and/or timing advances (e.g., at WTRU) are provided herein. If a WTRU is scheduled with an uplink transmission in a set of frequency resources (e.g., subbands) in an SBFD slot, the WTRU may require to use/employ timing advance techniques in a respective UL transmission.

The WTRU may receive/be configured with one or more timing alignment configuration indications (e.g., from a gNB, serving cell or one or more TRPs). For example, one or more of the following may apply: a timing advance offset indication; an absolute time advance command indication; or a timing advance adjustments command indication. For a timing advance offset indication, the WTRU may receive/determine the timing advance offset (e.g., cell-specific timing advance offset) for the serving cell (e.g., based on duplex mode and/or FR). For an absolute timing advance command indication, the WTRU may receive a TAC as part of/along with a random-access response (e.g., via MAC-CE) for the configuration (e.g., initial configuration) of the (e.g., WTRU-specific) timing advance (e.g., absolute timing advance). For a timing advance adjustments command indication may apply, the WTRU may receive TACs (e.g., via MAC-CE) for the adjustment of the current/determined (e.g., WTRU-specific) timing advance.

In examples, a WTRU may determine the timing advance (e.g., TA(new) based on the determined (e.g., previously determined) timing advance and/or received/configured TACs. The WTRU may determine the number of symbols (e.g., N) that are used (e.g., required) to accommodate the determined timing advance (e.g., TA(new). The WTRU may report the determined number of affected symbols (e.g., report N to gNB).

If a WTRU is scheduled with back-to-back downlink and uplink (e.g., or UL and DL) transmission in a set of frequency resources (e.g., subbands) in an SBFD slot, the WTRU may account (e.g., require to account) for the Rx-Tx (e.g., or Tx-Rx) switching timing used (e.g., required) in respective UL transmission (e.g., or DL reception). In examples, a WTRU may determine the switching time and the number of symbols (e.g., N) that are used (e.g., required) to accommodate the determined switching time. The WTRU may report its capability on the required Rx-Tx (e.g., or Tx-Rx) switching timing. The number of symbols (e.g., N) may be determined (e.g., by the WTRU and/or by the gNB) based on the reported capability on the required Rx-Tx (or Tx-Rx) switching timing.

A WTRU may determine if there is enough time before scheduled UL transmission to account for the determined timing alignment (e.g., due to timing advance and/or DL/UL switching time) and the determined number of affected symbols (e.g., N). The WTRU may determine the time discrepancy and the number of symbols that may be affected (e.g., delta_N) based on the difference between the determined timing (e.g., timing advance such as TA(new) and the configured time (e.g., from gNB) to account for the timing alignment (e.g., due to timing advance and/or switching time). In examples, the WTRU may determine the number of symbols affected due to the timing alignment discrepancy (e.g., due to timing advance and/or switching time such as delta_N). The WTRU may use the determined number of symbols (e.g., N) that are used (e.g., required) to accommodate the determined timing alignment and the configured number of symbols (e.g., from gNB) to account for the timing alignment (e.g., N′). As such, the WTRU may determine the number of symbols affected due to the timing alignment (e.g., due to timing advance and/or switching time) discrepancy (e.g., delta_N) based on the difference between the number of symbols determined at WTRU and the number of symbols configured by gNB (e.g., delta_N=N−N′).

Examples of indications of the configured timing alignment (e.g., due to timing advance and/or switching time) at a gNB are provided herein. In examples, a WTRU may determine the configured time/symbols (e.g., from the gNB) to account for the timing alignment (e.g., due to timing advance and/or switching time). One or more of an explicit indication and an implicit indication may apply. For the explicit indication, the WTRU may receive/be configured with the time/number of symbols configured/considered for timing alignment before the respective scheduled UL SBs/resources (e.g., in an SBFD slot) at the gNB (e.g., via DCI, MAC CE, etc.). The implicit indication may include one or more of UL/DL scheduled resources or UL schedule resources. For UL/DL scheduled resources, the WTRU may determine the time/number of symbols configured/considered for timing alignment before the respective scheduled UL SBs/resources (e.g., in an SBFD slot) based on back-to-back scheduled resources for DL and UL. For example, for a scheduled UL subband in an SBFD slot, the WTRU may detect/determine that there is one or more symbol gaps (e.g., N′) considered at the end of the scheduled resources for the preceding DL slot/subband (e.g., in an SBFD slot). For UL scheduled resources, the WTRU may determine that the gNB is considered to account for the timing alignment within a respective UL SBs/slot (e.g., in an SBFD slot). For example, for a scheduled UL subband in an SBFD slot, the WTRU may detect/determine that there is one or more symbol gaps (e.g., N′) considered at the beginning of the scheduled resources for the respective UL slot/subband (e.g., in an SBFD slot). For example, for a scheduled UL subband in an SBFD slot, the WTRU may detect/determine that a second/special/different type of PUSCH is scheduled. For this type of PUSCH, one or more candidate positions within the UL SBs/slot may be indicated for the UL transmission. As such, the WTRU may determine to start UL transmission in a candidate position that accounts for the determined timing alignment (e.g., new timing advance such as TA(new), and/or switching time). The gNB may determine (e.g., and/or indicate to the WTRU) the length of this second/special/different type of PUSCH based on a flexible slot's duration or based on the reported timing alignment from the WTRU (e.g., timing advance such as TA(new), and/or switching time).

Examples of reporting or suggesting the determined timing alignment discrepancy are provided herein. In examples, a WTRU may determine that there is not enough time/number of symbols considered/allocated/scheduled (e.g., from gNB) for a timing alignment (e.g., due to timing advance and/or switching time) based on the determined timing advance. The WTRU may indicate such a scheme as timing alignment discrepancy (e.g., due to timing advance and/or switching time). As such, the WTRU may report the timing alignment (e.g., timing advance such as TA(new), and/or switching time), the determined number of symbols used (e.g., required) for the timing alignment (e.g., N), and/or the number of symbols affected due to the timing alignment discrepancy (e.g., delta_N). The WTRU may determine to change (e.g., may determine to send a request message for changing) its mode of operation due to the determined timing alignment discrepancy. The WTRU may (e.g., in such a case) report, recommend, request, and/or suggest respective determined/preferred mode of operation. One or more of the following may apply: an ACK transmission; a PUCCH transmission; or a PUSCH transmission. The ACK transmission (e.g., a feedback message/indication in response to receiving a TAC) may include one of more a TAC-ACK or a single flag. For the TAC-ACK, the WTRU may send an ACK message (e.g., TAC-ACK and/or a feedback message/indication in response to receiving a TAC) including the information regarding the timing alignment discrepancy and/or the determined/preferred mode of operation. For a single flag, the WTRU may a include a flag (e.g., single flag bit) in an ACK message to indicate the timing alignment discrepancy. Based on the single flag, one or more of the following may apply. Flag value 0 may apply, which may indicate that the timing alignment (e.g., timing advance and/or switching time) is fine and no discrepancy is detected. Flag value 1 may apply, which in examples, may indicate that the timing alignment discrepancy is detected and that more time/symbols are used (e.g., required) for the respective UL transmission and the WTRU may send timing alignment discrepancy and/or determined/preferred mode of operation (e.g., within ACK). Flag value 1 may apply, which in examples, may indicate that the timing alignment discrepancy is detected and that the gNB may choose (e.g., be desired, be recommended, and/or be better) to wait and/or schedule an UL transmission (e.g., in an UL-only or flexible slot) to receive a respective timing alignment discrepancy and/or determined/preferred mode of operation from the WTRU. This indication from the WTRU may be classified with different levels of priority on the recommendation. For example, the flag value 1 may be interpreted as a normal-priority recommendation signal and the gNB may choose to wait and/or schedule an UL transmission (e.g., in an UL-only or flexible slot) to receive respective timing alignment discrepancy and/or determined/preferred mode of operation from the WTRU, in response to receiving the flag value 1. For example, there may be a flag value 2 having a higher priority than the flag value 1, and after sending the flag value 2, the WTRU may expect that the gNB chooses to wait and/or schedules an UL transmission (e.g., in an UL-only or flexible slot) to receive a respective timing alignment discrepancy and/or determined/preferred mode of operation from the WTRU (e.g., unless one or more pre-defined conditions (e.g., for exception) are met). For the PUCCH transmission, the WTRU may report the determined timing alignment discrepancy and/or determined/preferred mode of operation via a PUCCH transmission (e.g., including or not including scheduling request). For the PUSCH transmission, the WTRU may report the determined timing alignment discrepancy and/or determined/preferred mode of operation via UCI, MAC-CE, etc. in a PUSCH transmission.

In examples, the WTRU may receive a command/trigger/configuration/control signal (e.g., from gNB via DCI, MAC-CE, and/or the like) including the confirmation and/or updates/changes (e.g., required updates/changes) of the suggested timing alignment parameters and/or mode(s) of operation. In examples, the WTRU may receive a scheduled grant to fallback or use UL-only or flexible slots for respective UL transmission.

A WTRU may be configured (e.g., by default) to operate in a first mode of operation. In examples, the WTRU may determine that the configured first mode of operation is not the best mode, which may result in dropping the scheduled UL transmission (e.g., due to the discrepancies in timing advance configuration and/or switching time requirements). In such a case, the WTRU may determine to operate in a second mode of operation (e.g., to incorporate a determined guard time period for the timing alignment within UL and DL slots).

A first mode of operation may include preceding DL symbol puncturing (e.g., shortening, truncating, and/or rate matching). If a WTRU is scheduled with an uplink transmission in a set of frequency resources (e.g., subbands) in an SBFD slot, the WTRU may determine or be configured to operate in a first mode of operation (e.g., by default). The first mode of operation may be based on preceding DL symbols being punctured, shortened, truncated, and/or rate-matched (e.g., by gNB implementation). The WTRU may determine that the timing alignment (e.g., timing advance and/or switching time) configured (e.g., at the gNB) is in accordance with the determined timing alignment (e.g., at the WTRU). As such, the WTRU may determine that the required timing alignment gap period is considered in the preceding DL slot (e.g., in an SBFD slot), and that it has been considered as part of scheduling the DL resources.

The WTRU may be triggered to select the first mode of operation in cases where a time discrepancy is detected. The WTRU may be configured with a time/number of symbols duration/limit (e.g., TTA, Processing). The configured time/symbols may be the time that is used (e.g., required for a gNB) to receive, process, and take into effect operations (e.g., required operation such as to extend the timing advance and/or switching time) of a gap period in the preceding scheduled DL resources/SBs (e.g., in an SBFD slot) based on the reported information from the WTRU on the timing alignment discrepancy detection.

Based on detection of the timing alignment discrepancy, the WTRU may verify/determine if there is enough time duration (e.g., time >T_{TA,Processing}) between the WTRU reporting the timing alignment discrepancy information and UL scheduled resources/SBs (e.g., next/upcoming UL scheduled resources/SBs in an SBFD slot). If the time length/number of symbols between the WTRU reporting the timing alignment discrepancy information and UL scheduled resources/SBs (e.g., next/upcoming UL scheduled resources/SBs in an SBFD slot) is more than the time required (e.g., by a gNB) to process and apply the detected timing alignment discrepancy (e.g., TTA, Processing), the WTRU may determine to operate in the first mode of operation. If the time length/number of symbols between the WTRU reporting the timing alignment discrepancy information and UL scheduled resources/SBs (e.g., next/upcoming UL scheduled resources/SBs in an SBFD slot) is less than the time required (e.g., by gNB) to process and apply the detected timing alignment discrepancy (e.g., TTA, Processing), the WTRU may not determine to operate in the first mode of operation (e.g., the WTRU may determine to operation in a second mode of operation instead of the first mode of operation).

A WTRU may be configured with one or more priority levels for the UL and/or DL scheduled resources/SBs (e.g., in an SBFD slot). The WTRU may determine, based on the one or more priority levels, at least one mode of operation among pre-defined or pre-configured mode of operations (e.g., among the first mode of operation including preceding DL symbol puncturing, the second mode of operation including UL symbol puncturing, etc.). An explicit indication and/or an implicit indication may apply.

For the explicit indication, the WTRU may be configured, determine, or receive one or more priority levels (e.g., from gNB via DCI, MAC-CE, and/or the like). For the explicit indication, the priority levels may be indicated/configured/determined as part of scheduling configuration for the respective UL resources/SBs (e.g., in an SBFD slot). For the explicit indication, in examples the priority levels may indicate that the respective scheduled UL resources/SBs (e.g., in an SBFD slot) have a higher priority than the preceding scheduled DL resources/SBs. In examples, the priority levels may indicate if the preceding scheduled DL resources/SBs (e.g., in an SBFD slot) have higher priority than the respective scheduled UL resources/SBs.

F For the implicit indication, the WTRU may determine the priority level based on the most recent grant for UL/DL scheduling. For the implicit indication, the WTRU may be scheduled (e.g., configured grant via MAC-CE) with UL resources/SBs (e.g., in an SBFD slot). If the WTRU receives a grant (e.g., dynamic grant) for scheduled DL resources/SBs in the slot preceding the respective configured UL, the WTRU may determine that the scheduled DL resources/SBs have a higher priority than the originally configured UL resources/SBs. In response to the determination, the WTRU may apply a UL symbol puncturing on the part of the transmission including the UL resources/SBs (e.g., by applying the second mode of operation as an exceptional case) or may drop/skip transmitting the UL resources/SBs. The WTRU may (e.g., may then) continue to apply the first mode of operation (e.g., preceding DL symbol puncturing) based on determining that the first mode of operation is a current/default mode to be used/maintained and/or the second mode of operation was applied due to the exceptional condition that the WTRU received the grant for scheduled DL resources/SBs in the slot preceding the respective configured UL.

In examples, in the case where a WTRU detects a timing alignment discrepancy for UL scheduled resources/SBs (e.g., in an SBFD slot), the WTRU may verify/determine (e.g., first verify/determine) if the conditions on the processing time (e.g., as described herein) are satisfied. The WTRU may determine the priority level for respective UL resources/SBs and the preceding DL resources/SBs. If the conditions on processing time are satisfied and if the preceding DL resources do not have a higher priority than the respective UL resources, the WTRU may determine to operate in the first mode of operation (e.g., determine to transmit all symbols associated with the grant allocation). In examples, a WTRU may be operating in a mode of operation other than the first mode of operation if the WTRU detects a timing alignment discrepancy for UL scheduled resources/SBs (e.g., in an SBFD slot). The WTRU may determine if the conditions on the processing time (e.g., as described herein) are satisfied. If the conditions on processing time are satisfied, the WTRU may determine the priority level for respective UL resources/SBs and the preceding DL resources/SBs. If the preceding DL resources do not have a higher priority than the respective UL resources, the WTRU may determine to operate in the first mode of operation (e.g., determine to transmit all symbols associated with the grant allocation).

In examples, although the WTRU may verify/determine that the conditions on processing time are satisfied, the WTRU may determine that the preceding DL resources have a higher priority than the respective UL resources. The WTRU may (e.g., in this case) determine not to operate in the first mode of operation and to select/operate in another mode of operation. If the WTRU determines that the preceding DL resources/SBs (e.g., in an SBFD slot) have a higher priority than the respective UL resources/SBs, the WTRU may determine not to operate in the first mode of operation and to select/operate in another mode of operation. If the WTRU receives an indication (e.g., from a gNB) that the preceding DL resources/SBs cannot be punctured and/or used as gap period for the respective UL resources/SBs, the WTRU may determine not to operate in the first mode of operation and to select/operate in another mode of operation.

A second mode of operation may be described herein. UL symbol puncturing (e.g., shortening, truncating, and/or rate matching) may be provided in the second mode of operation. In examples, if a WTRU is scheduled with an uplink transmission in a set of frequency resources (e.g., subbands in an SBFD slot), the WTRU may determine/detect timing alignment discrepancies (e.g., as described herein). The WTRU may (e.g., as such) determine to operate in a second mode of operation to address the timing alignment discrepancies (e.g., puncture at least part of the transmission that uses the grant allocation).

The second mode of operation may be based on accounting for the timing alignment discrepancy within respective UL resources/SBs (e.g., in an SBFD slot). In examples, the WTRU may be configured (e.g., already configured) with a timing alignment guard time period. The WTRU may determine that the configured time period is shorter than the determined/required guard time period. In examples, the WTRU may not be configured with a timing advance (e.g., any timing advance and/or switching time in the preceding DL resources/SBs). As such, the WTRU may account (e.g., need to account) for the determined timing alignment (e.g., discrepancy).

The WTRU may use the scheduled UL resources/SBs (e.g., in an SBFD slot) to accommodate/incorporate the timing alignment discrepancy. The WTRU may adjust the data and control bits so that enough gap is available for the timing advance (e.g., and/or switching time) guard time period (e.g., a gap equal to the timing discrepancy such as delta_N). For example, for a slot with M symbols (e.g., M equal to 14), the WTRU may determine the number of available symbols to transmit the UL data and control (e.g., equal to M-delta_N). The WTRU may (e.g., as such) determine to use rate-matching strategies (e.g., shortening, puncturing, and/or the like) to incorporate the timing alignment discrepancy.

If one or more timing advances are configured (e.g., already configured) in the preceding DL resources/SBs, the WTRU may determine to start the UL transmission in advance (e.g., based on configured timing advance). Since there was a timing advance discrepancy, the UL transmission may be received (e.g., at the gNB) with a delay (e.g., delta_N). As such, the WTRU may determine to apply rate-matching strategies (e.g., shortening, puncturing, and/or the like) to have the UL slot end at the time that is used (e.g., required) (by the gNB). The WTRU may determine the rate-matching strategies based on the timing advance discrepancy. In examples, the WTRU may determine to apply rate-matching strategies to the respective UL resources/SBs (e.g., in an SBFD slot), while making sure that the DM-RS signals are not punctured.

In examples, for the case where switching time (e.g., enough switching time) is not configured in the preceding DL resources/SBs, the WTRU may determine to start the UL transmission with delay (e.g., based on configured switching time). The WTRU may determine the delay time based on the switching time discrepancy (e.g., delta_N). The WTRU may apply the delay time by skipping the first (e.g., delta_N) symbols within the UL SBFD slot and starting the UL transmission in the symbol following/after the applied delay. In examples, the WTRU may apply the delay time by skipping the last (e.g., delta_N) symbols within the UL SBFD slot and starting the UL transmission in the symbol following/after the applied delay. The WTRU may (e.g., as such) determine to apply rate-matching strategies (e.g., shortening, puncturing, and/or the like) to have the UL control and date to fit within the respective slot. The WTRU may determine the rate-matching strategies based on the switching time discrepancy. The WTRU may determine to apply rate-matching strategies to the respective UL resources/SBs (e.g., in an SBFD slot) (e.g., while making sure that the DM-RS signals are not punctured).

The WTRU may be triggered to select a second mode of operation if a time alignment discrepancy is detected. In examples, based on detection of the timing alignment discrepancy, the WTRU may verify/determine if there is enough time duration (e.g., time >TTA, Processing) between the WTRU reporting the timing alignment discrepancy information and UL scheduled resources/SBs (e.g., next/upcoming UL schedules resources/SBs in an SBFD slot). If the time length/number of symbols between the WTRU reporting the timing alignment discrepancy information and UL scheduled resources/SBs (e.g., next/upcoming UL scheduled resources/SBs in an SBFD slot) is less than the time used (e.g., required by the gNB) to process and apply the detected timing alignment discrepancy (e.g., TTA, Processing), the WTRU may determine to operate in the second mode of operation.

The WTRU may determine or be configured with one or more priority levels for the UL and/or DL scheduled resources/SBs (e.g., in an SBFD slot). If the WTRU determines that the preceding DL resources/SBs have higher priority than the respective UL resources/SBs, the WTRU may determine to operate in the second mode of operation. The WTRU may determine or be configured to apply a rate-matching strategy to accommodate/incorporate the timing alignment discrepancy within the respective UL resources/SBs. If the rate-matching strategy results in puncturing one or more DM-RS symbols within the UL resources/SBs, the WTRU may determine to operate in the fourth mode of operation (e.g., to drop the respective UL transmission in an SBFD slot and/or fall back).

A third mode of operation may be provided that includes shorten CP method in a respective UL symbol. A WTRU may determine/detect timing alignment discrepancy in a scheduled uplink transmission in a set of frequency resources (e.g., subband(s) in an SBFD slot). The WTRU may (e.g., as such) determine to operate in a third mode of operation that is based on using guard time period at the beginning of the respective UL slot (e.g., in an SBFD slot) that is based on (e.g., created by) shortening the CP for one or more symbols (e.g., all of the symbols) within the slot.

A WTRU may determine to use the third of operation if the timing alignment discrepancy is lower than a determined/configured threshold. The WTRU may determine the CP for symbols (e.g., all symbols) within the slot to be shorter than normal CP length (e.g., based on a minimum limit). As such, the difference between the shortened CP lengths and normal CP lengths may be accumulated to be used as the guard time period at the beginning of the respective UL slot. The WTRU may determine that the preceding DL slot is configured with cyclic suffix, where the WTRU may use as extra time for accommodating the timing alignment discrepancy.

A fourth mode of operation may be provided as a fall-back. A WTRU may determine that in the case where WTRU operates in a mode of operation (e.g., any of the modes of operation as described herein), the WTRU may drop (e.g., need to drop) the entirety of scheduled UL or DL resources/SBs (e.g., in a SBFD slot). In examples, if the determined timing advance (e.g., and/or switching time) is longer than a configured/determined threshold (e.g., TA (max), the over-puncturing/rate-matching may result in dropping the scheduled UL or DL resources/SBs (e.g., in a SBFD slot). In examples, if the rate-matching strategy (e.g., puncturing, shortening, and/or the like) results in puncturing the DM-RS signals (e.g., in PUSCH) or one or more other reference signals (e.g., in PDSCH), the scheduled UL or DL resources/SBs (e.g., in a SBFD slot) may be dropped (e.g., need to be dropped). The WTRU may (e.g., in this case) send a request (e.g., via UCI, SR, and/or the like) indicating that considering the current timing advance/switching time, the UL/DL slots may be dropped. The WTRU (e.g., in this case) may determine, suggest, and/or request to be scheduled in UL-only of flexible slots (e.g., fallback).

The WTRU may receive one or more triggers, control commands, etc. that may result in shorter timing alignment discrepancy. For example, the WTRU may receive one or more TACs indicating shorter timing advance. The WTRU may determine a timing advance (e.g., TA(new)) and determine that the timing advance is shorter than the configured/determined threshold (e.g., TA (max)). The WTRU may (e.g., as such) determine to operate in another mode of operation (e.g., as described herein) and may send respective request, report, and/or suggestion (e.g., to the gNB).

A slot may include a first set of frequency resources and a second set of frequency resources. The first set of frequency resources and the second set of frequency resources may be located in a BWP. The first set of frequency resources may be used for uplink and the second set of frequency resources may be used for downlink. The frequency resources (e.g., described herein) may include at least one of subcarrier, physical resource block, resource block group, resource group for SBFD, or subband.

The slot including the first set of frequency resources and the second set of frequency resources in one or more symbols (e.g., OFDM symbols) may be referred to as SBFD slot. The slot including either the first set of frequency resources or the second set of frequency resources in one or more symbols may be referred to as normal slot (e.g., or non-SBFD slot, flexible slot, non-mixed slot, and/or legacy-TDD slot).

Examples of WTRU behavior if a UL transmission is scheduled in a SBFD slot with DL reception in the previous slot are provided herein. If a WTRU is scheduled with consecutive slots (e.g., two consecutive slots), where the first slot may be scheduled for downlink reception (e.g., PDCCH, PDSCH, and/or RS) and the second slot may be scheduled for uplink transmission (e.g., PUCCH, PUSCH, and/or SRS), one or more of the following may apply: the WTRU may perform in an operation mode if the second slot is a first type of slot (e.g., SBFD slot); the WTRU may determine an operation mode for the transmission and/or reception of the first slot and/or the second slot; or the WTRU may determine a priority between downlink and uplink.

For the WTRU performing in an operation mode if the second slot is a first type of slot (e.g., SBFD slot), the operation modes may include a first operation mode, a second mode, or a third operation mode. For the first operation mode (e.g., DL symbol puncturing), the WTRU may skip, puncture, and/or rate-match around the last N symbol(s) in the first slot (e.g., slot for DL reception), where the last N symbol(s) may be used as guard time for switching downlink to uplink. For the second operation mode (e.g., UL symbol puncturing), the WTRU may skip, puncture, and/or rate-match around the first N symbol(s) of the second slot (e.g., slot for UL transmission), where the first N symbol(s) may be used as guard time period for switching downlink to uplink. For the third operation mode (e.g., dropping either UL or DL), the WTRU may drop DL reception or UL transmission.

For determining an operation mode for the transmission and/or reception of the first slot and/or the second slot based on a semi-static configuration or a dynamic configuration. For the semi-static configuration, the WTRU may be indicated or configured by a gNB via a higher layer signaling (e.g., RRC and/or MAC-CE) which mode of operation to use. The configuration may be a frequency resource specific. For example, the WTRU may be configured with a first mode of operation for a first frequency resource and the WTRU may be configured with a second mode of operation for a second frequency resource. The frequency resource may be at least one of frequency range (e.g., FR1 and/or FR2), BWP, subband, RB, a group of RBs, subcarrier, or a group of subcarriers. For the dynamic configuration, a WTRU may determine an operation mode based on one or more of the following. The WTRU may determine the operation mode based on priority between downlink and uplink. For example, if downlink reception (e.g., PDSCH, PDCCH, and/or DL RS) is a higher priority than uplink transmission (e.g., PUSCH, PUCCH, and/or SRS), the second operation mode (e.g., UL symbol puncturing) may be used (e.g., otherwise, the first operation mode (e.g., DL symbol puncturing) may be used). The WTRU may determine the operation mode based on system configuration including at least one of numerology (e.g., subcarrier spacing and/or CP length), slot format configuration, BWP configuration (e.g., default BWP and/or initial BWP), number of SSBs, or carrier type (e.g., Pcell and/or Scell). The WTRU may determine the operation mode based on WTRU-specific configuration including at least one of PDCCH, PUCCH, SRS, CSI-RS, DM-RS, PDSCH, etc.

For the WTRU determining a priority between downlink and uplink, the priority may be determined based on at least one of the following: the physical channel between the uplink and downlink; a starting symbol of the uplink transmission; a number of available symbols for downlink and uplink; a data type; or an explicit indication.

For the priority being determined based on a physical channel priority between downlink and uplink, a PDSCH may be a higher priority than a PUSCH. If a WTRU is scheduled to receive PDSCH in the first slot and the WTRU is granted for PUSCH transmission in the second slot, the WTRU may determine that the downlink is a higher priority than the uplink. One or more of the following priority between downlink signal and uplink signal may be used: dynamic grant PDSCH (DG-PDSCH) may have higher priority than dynamic grant PUSCH (DG-PUSCH) (e.g., without UCI), DG-PDSCH may have lower priority than DG-PUSCH (e.g., with UCI), DG-PDSCH may have lower priority than PUCCH, and DG-PDSCH may have lower priority than SRS; dynamic grant may be higher priority than configured grant (e.g., DG-PDSCH may have higher priority than configured grant PUSCH (CG-PUSCH) and configured grant PDSCH (CG-PDSCH) (e.g., may have lower priority than DG-PUSCH); PDCCH may have higher priority than PUSCH (with/without UCI), PDCCH may have higher priority than PUCCH, and PDCCH may have higher priority than SRS; or DL-RS (e.g., CSI-RS, PRS, and/or TRS) may have a higher priority than SRS.

For the priority being determined based on the starting symbol of the uplink transmission, if the starting symbol for UL transmission in the second slot has a starting offset larger than a threshold, the downlink may be a higher priority (e.g., otherwise, uplink may be a higher priority). In examples, if the starting symbol for UL transmission in the second slot has a starting offset smaller than or equal to the threshold, one or more priority rules (e.g., physical channel priority) described herein may apply.

For the priority being determined based on number of available symbols for downlink and uplink, a link which may have a smaller number of available symbols may be determined as a higher priority. For example, if the number of available symbols for downlink is larger than that of uplink symbol, uthe plink may be determined as a higher priority.

For the priority being determined based on data type, a downlink may be used, scheduled, or determined for a first data type (e.g., URLLC) and uplink may be used, scheduled, or determined for a second data type (e.g., eMBB). The downlink may be determined as a higher priority. The data type may be indicated in the scheduling DCI (e.g., using priority index field, where priority index=1 may be referred to as a first data type and priority index=0 may be referred to as a second data type, or vice-versa).

For the priority being determined based on an explicit indication, a scheduling DCI for uplink or downlink may indicate which link is prioritized.

Examples of WTRU behavior when both DL and UL are scheduled in a SBFD slot are provided herein. In examples, a WTRU may be scheduled for DL reception (e.g., PDSCH) and UL transmission (e.g., PUSCH, PUCCH, and/or SRS) in the same SBFD slot, where the DL reception may be in the first frequency resource and the UL transmission may be in the second frequency resource. If the DL reception and UL transmission are time multiplexed (e.g., scheduled in different symbols within the SBFD slot), one or more of the following operation modes may be used: a first operation mode; a second operation mode; or a third operation mode. For the first operation mode (e.g., DL symbol puncturing), the WTRU may skip, puncture, and/or rate-match around the last N symbol(s) of downlink symbols (e.g., symbols used or scheduled for downlink), where the last N symbol(s) may be used as guard time for switching downlink to uplink. For the second operation mode (e.g., UL symbol puncturing), the WTRU may skip, puncture, and/or rate-match around the first N symbol(s) of the uplink symbols (e.g., symbols used or scheduled for uplink), where the first N symbol(s) may be used as guard time for switching downlink to uplink. For the third operation mode (e.g., dropping either UL or DL), the WTRU may drop DL reception or UL transmission in the slot.

If the DL reception and UL transmission are frequency multiplexed (e.g., one or more scheduled symbols are overlapped fully or partially in time domain), the third operation mode (e.g., dropping either UL or DL) may be based on one or more of following: a priority determined between downlink and uplink; a scheduling timing for downlink and uplink; or a link determined for a previous slot. For scheduling timing for downlink and uplink, the link with scheduling DCI received later may be determined as a higher priority. In examples, a PDSCH may be scheduled in the DCI received in slot #n, a PUSCH may be scheduled in the DCI received in the slot #n+2; and both PDSCH and PUSCH may be scheduled in the slot #n+5. The WTRU may determine the PUSCH is higher priority. For the link determined for the previous slot, if the previous slot is determined, used, or configured to be used for downlink, the downlink reception may be higher priority in SBFD slot (e.g., otherwise, the uplink transmission may be higher priority or vice-versa).

If one or more symbols for downlink or uplink are skipped for a guard time, the one or more symbols may be punctured or rate-matched around. Puncturing may be referred to as the case where a WTRU may skip transmitting/receiving the REs in the orthogonal frequency divisional multiplexing (OFDM) symbols which may be considered as available resource if the transmitter encodes data. Rate-matching may be referred to as the case where a WTRU may skip transmitting/receiving the REs in the OFDM symbols which may be considered as a non-available resource if the transmitter encodes data. A WTRU may perform puncturing or rate-matching for downlink reception or uplink transmission based on one or more of the following: a channel type (e.g., a WTRU may perform puncturing for downlink channels such as PDCCH, PDSCH while the WTRU may perform rate-matching for uplink channels such as PUSCH, PUCCH; a number of available symbols (e.g., if the number of available symbols is less than a threshold, a rate-matching may be used for the channel; otherwise, puncturing may be used); modulation and coding scheme (MCS) scheduled (e.g., if scheduled MCS is higher than a threshold, rate-matching may be used; otherwise, puncturing may be used); scheduling type (e.g., dynamic grant, configured grant and puncturing may be used for dynamic grant based scheduling and rate-matching may be used for configured grant based scheduling, or vice-versa); or explicit indication in the scheduling DCI.

A WTRU may receive an indication of a time-domain resource allocation (TDRA) for a PUSCH transmission. The WTRU may receive the indication by DCI in the case of a dynamic grant or configured grant type 2 or by RRC in the case of a configured grant type 1. The WTRU may determine that the PUSCH transmission is to be truncated by at least one symbol compared to the indicated TDRA. the WTRU may determine that the PUSCH transmission with non-zero power starts N symbols after the starting symbol indicated by the TDRA. In a first option, the WTRU may perform PUSCH processing based on a modified TDRA allocation that starts N symbols after the starting symbol indicated by the TDRA. In a second option, the WTRU may perform PUSCH processing based on the indicated TDRA and may puncture (e.g., or sets transmission power to zero) the N first symbols of the PUSCH (e.g., the delta_N as described herein). In the case where the number of remaining symbols of the PUSCH after truncation is lower than a pre-defined threshold (e.g., 2 symbols), the WTRU may cancel the PUSCH transmission (e.g., entire PUSCH transmission). The WTRU may determine whether to apply truncation and the number of truncated symbols N based on one or more of the following. The WTRU may determine based on an indication (e.g., explicit or implicit) from a DCI or a MAC CE. The DCI may be the DCI indicating the corresponding PUSCH or another DCI such as a WTRU-group common DCI. The WTRU may determine based on the timing of the slot in which the PUSCH transmission occurs. For example, truncation may occur (e.g., occur only) in slots identified by a time pattern. The pattern may be periodic and/or defined by a bitmap. The bitmap and/or periodicity may be signaled by DCI, MAC CE or RRC. The WTRU may determine based on a format or property of the slot in which PUSCH transmission occurs. For example, the WTRU may determine to apply truncation in (e.g., only in) slots for which sub-band full duplex operation is supported.

The WTRU may determine based on the number of symbols of the PUSCH that overlap with a set of protected symbols of the slot. For example, the M first symbols of the slot may be protected such that no PUSCH transmission occurs in these symbols. In such a case, truncation of the N=M-S first symbols of the PUSCH occurs if S<M, where S is the starting symbol index of the TDRA allocation. If S>=M, the WTRU may not truncate. The number of protected symbols M may be signaled by DCI or MAC CE. The WTRU may determine the number of protected symbols M based on its timing advance. For example, this number may be the smallest M such that the duration of the M protected symbols is larger than the timing advance. The WTRU may determine based on the type of grant for the PUSCH transmission. For example, the WTRU may apply truncation for (e.g., only for) configured grant type 1 or type 2 and not for dynamic grant. In the case of a PUSCH repetition (e.g., type A or type B), the WTRU may cancel a PUSCH repetition that overlaps with an M protected symbol (e.g., any of the M protected symbols) of a slot.

Examples of PUSCH mapping types are provided herein. A WTRU may be configured with one or more resource mapping(s) for one or more uplink transmission(s) (e.g., of a transport block (TB) (e.g., via a PUSCH). The WTRU may be scheduled in the time domain (e.g., via RRC, MAC-CE, DCI) based on configured and/or indicated resource mapping(s) for the UL (e.g., TB, via PUSCH) transmission(s). The WTRU may be configured, indicated, and/or receive configurations (e.g., via RRC, MAC-CE, DCI) including a list and/or table of resource allocation entries. In examples, the indexed rows in the configured list and/or table may indicate at least the slot offset (e.g., k2), the start and length indicator for the transmission (e.g., SLIV), the start symbol (e.g., S), the allocation length (e.g., L), the mapping type (e.g., for PUSCH (e.g., Type A or Type B)), the number of slots to be used (e.g., in multi-slot PUSCH transmissions), the number of repetitions, etc.

The WTRU may be configured, indicated, and/or receive configurations (e.g., via RRC, MAC-CE, DCI) including a list of entries indicating the time offsets to start a UL (e.g., TB) transmission. The WTRU may (e.g., may then) receive an indication (e.g., via MAC-CE, DCI, e.g., in the DCI field of the UL grant) indicating the entry from the configured list that may be used for selecting the slot offset that the WTRU may apply for the corresponding UL transmission.

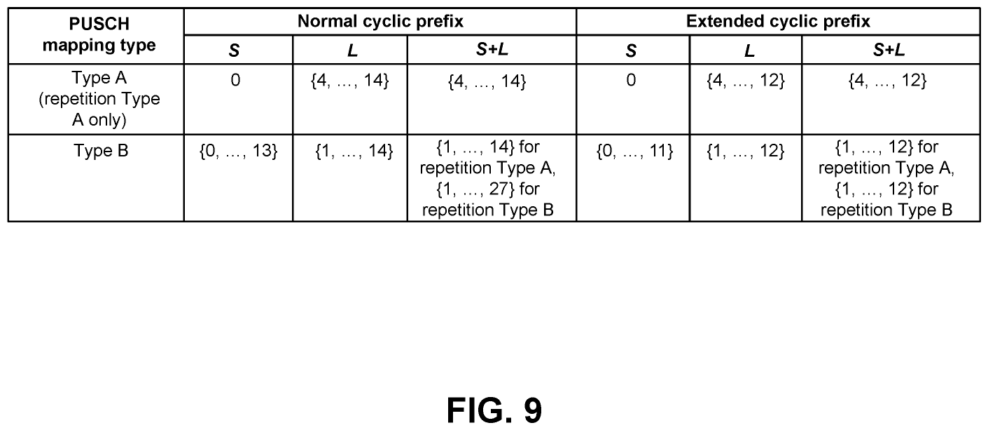

FIG. 9 shows an example of resource mapping (e.g., time-domain resource mapping) for PUSCH transmission(s) (valid S and L combinations). The figure shows a non-limiting example of the parameters that may be included. The number of bits, symbols, and choices for the parameters (e.g., each parameter) may be included. Other numbers of bits or choices may be included. The terms time-domain resource mapping, time-domain UL resource mapping, PUSCH resource mapping, PUSCH mapping, PUSCH mapping type A, and PUSCH mapping type B may be used interchangeably herein.

Examples of dynamic switching in PUSCH resource mapping settings are provided. A WTRU may be configured, receive configurations (e.g., via RRC, MAC-CE, DCI), or determine to use a first PUSCH resource mapping setting. The first PUSCH resource mapping setting may include at least a first PUSCH resource mapping type (e.g., mapping type A, mapping type B, etc.), a first starting symbol, a first allocation length, etc. The WTRU may (e.g., after using the first PUSCH resource mapping setting) receive an indication to switch to or use a second PUSCH resource mapping setting (e.g., a PUSCH resource mapping type A if previously using PUSCH resource mapping type B, or PUSCH resource mapping type B if previously using PUSCH resource mapping type A, etc.). The indication may indicate at least a second starting symbol, a second allocation length, etc. The WTRU may apply the changes received by the indication for at least one of: a specific transmission (e.g., DCI based); a time period (e.g., timer based); a number of transmissions (e.g., DCI or MAC-CE based); or until an indication to switch back (or again) is received (e.g., based on activation/deactivation that may be received in a DCI or MAC-CE).

The WTRU may receive the indication to use or switch to the second PUSCH resource mapping setting if sending (e.g., after sending) a request to use or switch the PUSCH resource mapping setting (e.g., a request to use or switch to the second PUSCH resource mapping type, a second starting symbol, a second allocation length, etc.). The second PUSCH resource mapping type, second starting symbol, and the second allocation length may be similar or different from the first PUSCH resource mapping type, first starting symbol, and first allocation length, respectively.

The indication to use (e.g., switch to) a PUSCH resource mapping setting (e.g., the second PUSCH resource mapping setting) and the use of the PUSCH resource mapping type, starting symbol, allocation length, etc. (e.g., based on the indication) may be for or may apply to at least one of: one or more cells (e.g., an indicated one or more cells); one or more PUSCH transmissions (e.g., an indicated one or more PUSCH transmissions); or one or more transmission priorities (e.g., applies to a first priority and not a second priority, or applies to an indicated or configured one or more priorities).

The WTRU may do one or more of the following: the WTRU may receive a configuration, an indication, or schedule for one or more transmissions (e.g., PUSCH); the WTRU may transmit a PUSCH based on the first PUSCH resource mapping setting for at least one of the transmissions; the WTRU may receive an indication to use or switch to a second PUSCH resource mapping setting (e.g., in a DCI or MAC-CE, or based on an RNTI); or the WTRU may transmit a PUSCH based on the second PUSCH resource mapping setting for at least one of the transmissions and/or for at least one other transmission (e.g., PUSCH).

The WTRU may use (e.g., may continue to use) the second PUSCH resource mapping setting until a time period expires or until another PUSCH resource mapping setting indication is received. A PUSCH resource mapping setting may be used as an example. Any other uplink or downlink signal or channel resource mapping setting may be used as the resource mapping and be consistent with the examples.

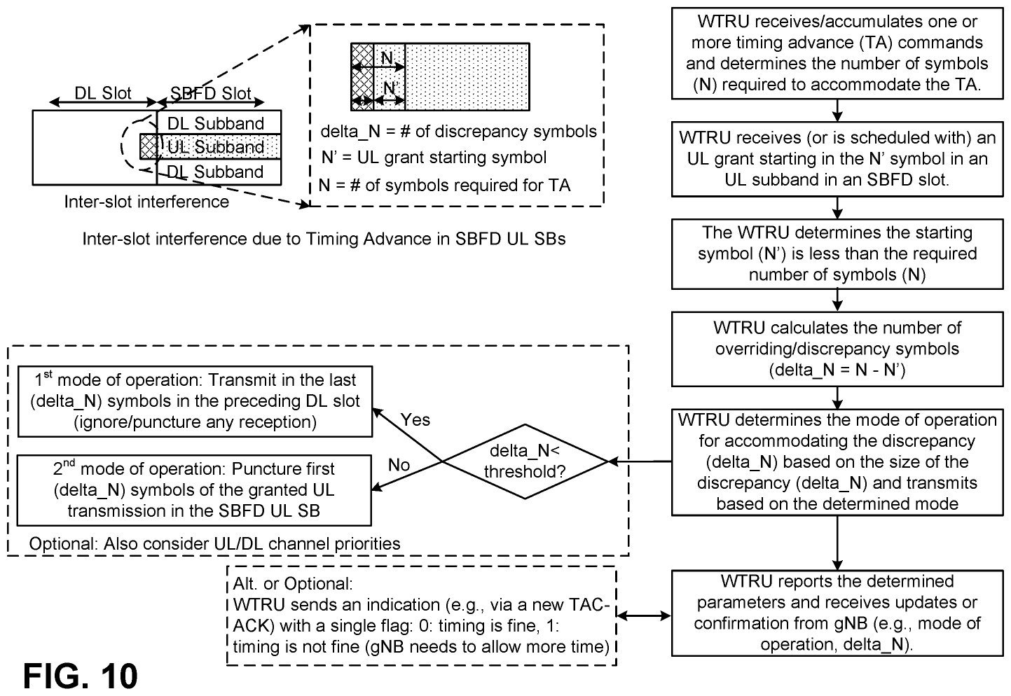

FIG. 10 illustrates an example associated with a WTRU handling a guard time period discrepancy in SBFD slots, where one or more of the following may be performed. The WTRU may determine and/or request to switch to a PUSCH resource mapping setting. The WTRU may receive and/or accumulate one or more timing advance commands (TACs) (e.g., via RRC, MAC-CE, DCI, RAR message, etc.). The WTRU may determine a guard time period (e.g., associated with the number of symbol(s) (e.g., N)) determined from the TACs (e.g., required to accommodate the timing advance). The WTRU may receive (e.g., or may be scheduled with) a grant allocation (e.g., a UL grant allocation via RRC, MAC-CE, DCI). The grant allocation may be associated with a number of starting symbol(s) (e.g., N′). The number of starting symbol(s) may be configured and/or indicted to be in a subband (e.g., a UL subband) in an SBFD time unit (e.g., symbol, slot, frame, subframe, etc.). The WTRU may determine that the number of starting symbol(s) (e.g., within the SBFD slot) (e.g., N′) is less than the required number of guard symbols to handle and/or accommodate the timing advance (e.g., N) (e.g., that the time associated with the number of starting symbol(s) is within the guard time period). The WTRU may calculate the difference between the time associated with the number of starting symbols and the start time of the guard time period (e.g., the number of overriding, overlapping, and/or discrepancy symbols (e.g., delta_N=N−N′).

A WTRU may determine to change and switch from a first PUSCH resource mapping setting to a second PUSCH resource mapping setting. The WTRU may determine whether to request (e.g., recommend or suggest) a change in the PUSCH resource mapping setting (e.g., based on the determined timing advance discrepancy (e.g., delta_N, as described herein).

In examples, the WTRU may be configured and/or indicated (e.g., via RRC, MAC-CE, DCI) to apply a first PUSCH resource mapping for one or more PUSCH transmissions (e.g., in an UL subband or BWP in SBFD configuration). The first PUSCH resource mapping setting may include a time associated with a number of starting symbol(s) (e.g., first starting symbol (e.g., within the slot, e.g., N′)). The WTRU may determine whether to truncate or puncture a part of a transmission that uses the grant allocation based on the size of the difference between the time associated with the number of starting symbol(s) and the start of the guard time period (e.g., the size of the timing advance discrepancy (delta_N)). In examples, the WTRU may calculate and determine that the timing advance discrepancy (delta_N) is higher than zero, and/or higher than a first threshold, where the threshold may be configured and/or indicated (e.g., via RRC, MAC-CE, DCI).

The WTRU may determine that the WTRU truncate or puncture part of the PUSCH transmission for one or more symbols based on one or more priorities (e.g., the transmission overlapping with a higher priority signal) and/or the value of the timing advance discrepancy (e.g., delta_N) being higher than the threshold (e.g., as shown in FIG. 10 and described herein). In examples, the WTRU may determine that the WTRU transmit the PUSCH transmission in all symbols associated with the grant allocation based on one or more priorities (e.g., the transmission not overlapping with a higher priority signal) and/or the value of the timing advance discrepancy (delta_N) being lower than the threshold (e.g., as shown in FIG. 10 and described herein). The WTRU may send the transmission based on the determination of whether to puncture or truncate the part of the transmission. The WTRU may report (e.g., to the network) the timing advance discrepancy (delta_N) (e.g., the difference between the time associated with the number of starting symbol(s) and the start of the guard time period).

Examples of changing, switching, and/or adjusting the PUSCH resource mapping setting are provided. The WTRU may determine to switch a configured and/or indicated first PUSCH resource mapping type and use a second PUSCH resource mapping type. In examples, the first PUSCH resource mapping type may be type A and/or type B.

If the determined timing advance discrepancy (e.g., delta_N) is higher than zero and/or higher than a first threshold and the WTRU is configured and/or indicated with a PUSCH resource mapping type A, the WTRU may determine to switch the resource mapping to type B. The WTRU may determine to use PUSCH resource mapping type B for one or more PUSCH transmissions. One or more of the following examples may apply: the WTRU may determine a second starting symbol (e.g., based on the determined number of symbols that are required to handle and/or accommodate the timing advance (e.g., second starting symbol could be N)); the WTRU may determine a second allocation length (e.g., based on the first starting symbol, first allocation length, second starting position, and the timing advance discrepancy (e.g., second allocation length=first allocation length-(second starting symbol-first starting symbol)=first allocation length-delta_N)); or the WTRU may determine the time-domain resource mapping for one or more of the reference signals (e.g., DMRS in PUSCH) (e.g., the WTRU may determine the DMRS to be transmitted at the first symbol of the second PUSCH resource mapping setting, that is indicated and/or determined based on the second starting symbol).

If the determined timing advance discrepancy (e.g., delta_N) is higher than zero and/or higher than a first threshold and the WTRU is configured and/or indicated with a PUSCH resource mapping type B, the WTRU may determine to change the starting symbol, allocation length, etc. for the resource mapping type B. The WTRU may determine to keep using PUSCH resource mapping type B and may use a second starting symbol and a second allocation length for one or more PUSCH transmissions. One or more of the following examples may apply: the WTRU may determine a second starting symbol (e.g., based on the determined number of symbols that are required to handle and/or accommodate the timing advance (e.g., second starting symbol could be N)); the WTRU may determine a second allocation length (e.g., based on the first starting symbol, first allocation length, second starting position, and the timing advance discrepancy (e.g., second allocation length=first allocation length-(second starting symbol-first starting symbol)=first allocation length-delta_N)); or the WTRU may determine the time-domain resource mapping for one or more of the reference signals (e.g., DMRS in PUSCH) (e.g., the WTRU may determine the DMRS to be transmitted at the first symbol of the second PUSCH resource mapping setting, that is indicated and/or determined based on the second starting symbol).

Examples of selecting the PUSCH resource mapping starting symbol and/or length are provided. A WTRU may be configured (e.g., via RRC, MAC-CE, DCI), indicated (e.g., via DCI, MAC-CE), and/or determine with a list of candidate starting symbols and/or allocation lengths for the PUSCH resource mapping settings, for one or more PUSCH transmissions.

The WTRU may (e.g., may then) receive an indication (e.g., via MAC-CE, DCI) to one of the entries in the list to use one of the starting symbols and/or allocation lengths for one or more PUSCH transmissions. The WTRU that is configured and/or indicated with a first entry from the list (e.g., indicating a first starting symbol and a first allocation length) may determine to use a second entry from the list (e.g., indicating a second starting symbol and a second allocation length).

If the WTRU determines that the determined timing advance discrepancy (e.g., delta_N) is higher than zero and/or higher than the first starting symbol, the WTRU may not use the first starting symbol. The WTRU may determine the next and/or the second starting symbol to start the PUSCH transmission. The WTRU may determine the allocation length and the time resource allocations for one or more RS (e.g., DMRS) accordingly.

Examples of requesting to switch PUSCH resource mapping settings are provided. A WTRU that is configured with a first PUSCH resource mapping setting may determine to indicate, report, request, suggest, or recommend a second PUSCH resource mapping setting (e.g., to a gNB). The WTRU may determine to indicate the second PUSCH resource mapping setting including a second PUSCH resource mapping type, a second starting symbol, a second allocation length, etc. The WTRU may indicate the number of symbols truncated, punctures, and rate-matched due to for example timing advance discrepancy. The WTRU may indicate if the truncation, puncturing, and/or rate matching may take place in the current PUSCH, next PUSCH, or one or more other PUSCH transmissions.

In examples, the WTRU may indicate the second PUSCH resource mapping settings via a MAC-CE (e.g., MAC-header along with PUSCH transmission). In examples, the WTRU may send the indication as part of periodic reporting (e.g., PUCCH, UCI), or aperiodic reporting (e.g., PUSCH).

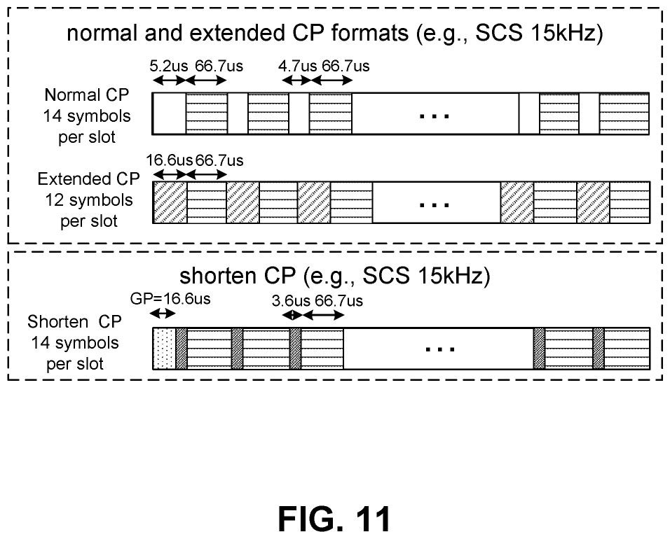

FIG. 11 shows an example of a shorten CP to accommodate a guard time period within an UL slot in SBFD SB.

A shorten CP technique may be described herein. In NR, one or more slot formats may be considered/configured based on cell range, frequency range, and/or the like. In examples, the slot formats with normal CP length may include 14 OFDM symbols, where the CPs (e.g., all the CPs) except for the first CP have the same length. In examples, the slot formats with extended CP lengths may include 12 OFDM symbols, where CPs (e.g., all CPs) have the same length (e.g., almost 4 times the CP length in normal CP slots), as shown in FIG. 11.

Longer CP length at the beginning of a slot (e.g., in SBFD) may be used to account for the timing advance and/or switching times. Doing this may include using extended CP (e.g., supported in an NR system) as shown in FIG. 11. Extended CP slots in NR may have a smaller number of symbols compared to normal CP slots (e.g., 12 versus 14 symbols) that may affect the channel's capacity. Examples of how to efficiently extend the CP length (e.g., in consideration of the timing advance and/or switching times) at the beginning of a slot (e.g., SBFD) without decreasing the capacity, coverage, and performance may be provided.

A WTRU may be configured/indicated to apply a shorten CP (e.g., as a third mode of operation being configured/indicated/applied) in transmission of an uplink signal (e.g., and/or in reception of a downlink signal for a group of WTRUs applying the shorten CP in the same way) in response to determining the timing alignment discrepancy (e.g., delta_N). In examples, the WTRU may receive one or more TACs, where the TAC may include configurations (e.g., or the WTRU may receive a separate message comprising the configurations) to account for timing advance in SBFD. For example, the configuration may include a timing advance threshold (e.g., TA_max) indicating the maximum timing advance for which shorten CP may be used. For example, the configuration may include one or more CP length limits (e.g., CP_min) indicating the minimum allowed CP length for the symbols in an UL slot in an SBFD SB (e.g., cell-common or WTRU-specific). The WTRU may determine TA(new) based on the received TAC(s).

The WTRU may determine to use shorten CP based on the TA(new) for respective UL SB/slot, for example, if TA(new) is lower than the configured threshold (TA_max). The WTRU may determine the timing alignment guard time period length at the beginning of respective UL slot based on (e.g., to be equal to) the TA(new). The WTRU may determine the shortened CP length for the symbols within the slot, accordingly (e.g., as shown in FIG. 11). The WTRU may report to the gNB that the WTRU determines to use shorten CP. The WTRU may (e.g., may additionally) report the timing alignment guard time period length in respective UL slot in SBFD SB. For example, the WTRU may report the GP length using a coefficient with reference to configured TA_max (e.g., ¼, ½, ⅔, and/or 1). For the third mode of operation based on the shorten CP technique in a respective UL SB/slot, CP lengths (e.g., all CP lengths) within the UL SB/slot may be reduced (e.g., based on a configured limit). The WTRU may determine to use this mode if a TA length is shorter than a configured time. In examples, the WTRU may use cyclic suffix in the last symbol of the preceding DL SB/slot (e.g., in addition to CP in the first symbol of the UL SB/slot). The WTRU may determine that shorten CP cannot be used, for example, based on TA_max and/or CP_min, etc. In response to the determination, the WTRU may determine another mode of operation to be used/applied, among pre-defined or pre-configured mode of operations, for example, among the first mode of operation including preceding DL symbol puncturing, the second mode of operation including UL symbol puncturing, etc. The WTRU may determine/request to be scheduled to operate in UL only or flexible slots with explicit guard times (e.g., not in SBFD). The WTRU may report/recommend using another mode of operation among pre-defined or pre-configured mode of operations, for example, among the first mode of operation including preceding DL symbol puncturing, the second mode of operation including UL symbol puncturing, etc.

Fallback schemes may be provided. A WTRU may identify a mode of operation to be used/applied/maintaining (e.g., as a current mode of operation), among pre-defined or pre-configured mode of operations, for example, among the first mode of operation including preceding DL symbol puncturing, the second mode of operation including UL symbol puncturing, the third mode of operation including shorten CP technique in respective UL SB/slot, etc.

The WTRU may determine that in the case where the WTRU operates in a mode (e.g., any of the modes) of operation (e.g., as described herein), the WTRU may to drop (e.g., need to drop) the whole scheduled UL or DL resources/SBs (e.g., in a SBFD slot). In examples, if the determined timing advance (e.g., and/or switching time) is longer than a configured/determined threshold (e.g., TA (max), the over-puncturing/rate-matching may result in dropping the scheduled UL or DL resources/SBs (e.g., in a SBFD slot). For example, if the rate-matching strategy (e.g., puncturing, shortening, and/or the like) results in puncturing the DM-RS signals (e.g., in PUSCH) or one or more other reference signals (e.g., in PDSCH), the scheduled UL or DL resources/SBs (e.g., in a SBFD slot) may be dropped (e.g., need to be dropped).

The WTRU may determine that the current mode of operation leads to dropping a UL and/or DL SB in slot(s) with SBFD, if one or more of the following conditions are met: if a TA length (e.g., TA_new) is larger than a first threshold (e.g., a configured time window); if the codeword formation (e.g., shifting) in a slot in UL/DL SBFD SB uses (e.g., requires) DMRS puncturing (e.g., due to incorporating the guard time period, the respective slot will be dropped); or if the WTRU receives a control command (e.g., DCI format 2_4, a group-common DCI, a DCI for a transmission cancelation, etc.) from the gNB.

The WTRU may receive one or more triggers, control commands, etc. that may result in shorter timing alignment discrepancy. For example, the WTRU may receive one or more TACs indicating shorter timing advance. The WTRU may determine a timing advance (e.g., TA(new)) and may determine that the timing advance is shorter than the configured/determined threshold (e.g., TA (max). The WTRU may (e.g., such as) determine to operate in another mode of operation (e.g., as described herein) and may send respective request, report, and/or suggestion (e.g., to the gNB). In response to the determining that the current mode of operation leads to dropping a UL and/or DL SB in slot(s) with SBFD, the WTRU may apply one or more of the following: the WTRU may send (e.g., to the gNB) a request (e.g., via UCI, SR, and/or the like) indicating that considering the current timing advance/switching time, the UL/DL slots may be dropped and/or suggesting to be scheduled in UL-only or flexible slots (e.g., genuine UL-only or flexible slots in non-SBFD slot); the request may include/indicate a recommendation of changing/switching the current SBFD slot configuration/format (e.g., DXXFU) to another SBFD slot configuration/format (e.g., DDXFU) (e.g., ‘D’, ‘X’, ‘F’, and ‘U’ may refer to ‘downlink’, ‘SBFD’, ‘flexible’, and ‘uplink’, respectively, and the WTRU may send the request based on determining the second (e.g., indexed/positioned) slot ‘X’ may be better/preferred to be changed to a pure downlink ‘D’ without SBFD operation and the associated UL transmissions on the second (e.g., indexed/positioned) slot may need (e.g., be better) to be moved to slots with ‘F’ and/or ‘U’ and the WTRU may send, via a separate/independent signaling, the recommendation message for changing/switching the current SBFD slot configuration/format to another SBFD slot configuration/format, (e.g., based on pre-defined/pre-configured rule(s) or condition(s) being met)); or the WTRU may determine to operate in the fourth mode of operation (e.g., to drop the respective UL transmission in an SBFD slot and/or fall back) (e.g., based on the fourth mode of operation, the WTRU may temporally (e.g., exceptionally, as a one-time behavior) drop the respective UL transmission in an SBFD slot, and after that the WTRU may apply the current mode of operation being used/maintaining). The WTRU may be configured/indicated with a counter parameter, where the WTRU may increase the counter parameter value when the WTRU drops the respective UL transmission in an SBFD slot (e.g., consecutively and/or within a pre-defined/pre-configured time window/duration). If the counter parameter value exceeds a pre-defined/pre-configured threshold, the WTRU may stop applying the fourth mode of operation and fallback to a default mode of operation (e.g., the first or second mode of operation or a pre-defined default mode for which one or more slot(s) are disabled to be used for SBFD and operated as non-SBFD slot(s)).

Examples of forming the codeword for data and control multiplexing are provided herein. Examples of determining used REs (e.g., required REs) in the PUSCH piggybacking the UCI are provided herein. A WTRU may determine the number of coded-modulation symbols (e.g., per layer) for the UCI transmission on PUSCH. The UCI may carry control information. The UCI may include or carry HARQ-ACK, CSI part 1, CSI part 2, and/or the like. The term UCI may be used to represent the control content, information, payload, and/or bits carried by the PUSCH. The PUSCH may be the physical channel that may include control (e.g., UCI), data (e.g., UL-SCH) and respective reference signals (e.g., DMRS).

An example of equation for determining the number of coded modulated symbols per layer for HARQ-ACK transmission on PUSCH

$$( e . g . , {Q}_{A C K}^{′} )$$

may be provided below and in Table 1.

$${Q}_{A C K}^{′} = min \{ ⌈ \frac{( {O}_{A C K} + {L}_{A C K} ) \cdot {β}_{offset}^{PUSCH} \cdot {\sum }_{l = 0}^{{N}_{s y m b , all}^{PUSCH} - 1} {M}_{s c}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{s y m b , all}^{PUSCH} - 1} {M}_{sc}^{UCI} ( l ) ⌉ \}$$

Table 1 and the above equation may include parameters that may be included in determining the number of coded modulated symbols per layer for HARQ-ACK, while considering single slot procedure and not using repetition type B with UL-SCH. One or more of those parameters may be included. The number of bits and choices for a parameter (e.g., each parameter) may be shown as examples. In examples, other numbers of bits or choices may be included.

TABLE 1
Example of Parameters for Determining the Number of Coded-Modulated Symbols for
HARQ-ACK transmission on PUSCH

| Parameter | Description |
|---|---|
| O_{ACK} | Number of HARQ-ACK bits |
| L_{ACK} | If O_{ACK} ≥ 360, L_{ACK} = 11; otherwise L_{ACK} is the number of CRC bits for HARQ-ACK |
| ${β}_{offset}^{PUSCH}$ | $Equal to {β}_{offset}^{H A R Q - ACK}$ |
| C_{UL-SCH} | Number of code blocks for UL-SCH of the PUSCH transmission |
| Kᵣ | The r -th code block size for UL-SCH of the PUSCH transmission |
| ${M}_{s c}^{PUSCH}$ | Scheduled bandwidth of the PUSCH transmission, expressed as a number of subcarriers |
| ${M}_{s c}^{PT - RS} ( l )$ | Number of subcarriers in OFDM symbol l that carries PTRS, in the PUSCH transmission |
| ${M}_{s c}^{UCI} ( l )$ | Number of resource elements that can be used for transmission of UCI in OFDM symbol l, for |
| | $l = 0 , 1 , 2 , … , {N}_{symb , all}^{PUSCH} - 1 , in the PUSCH transmission .$ |
| | $for any OFDM symbol that carries DMRS of the PUSCH , {M}_{s c}^{UCI} ( l ) = 0 ;$ |
| | $for any OFDM symbol that does not carry DMRS of the PUSCH , {M}_{s c}^{UCI} ( l ) = {M}_{s c}^{PUSCH} -$ |
| | ${M}_{s c}^{PT - RS} ( l ) ;$ |
| ${N}_{symb , all}^{PUSCH}$ | Total number of OFDM symbols of the PUSCH, including all OFDM symbols used for DMRS |
| α | Configured by higher layer parameter scaling |
| lₒ | Symbol index of the first OFDM symbol that does not carry DMRS of the PUSCH, after the first |
| | DMRS symbol(s), in the PUSCH transmission. |

The WTRU may determine that rate-matching is used (e.g., required) or be configured with rate-matching for a PUSCH. The WTRU may (e.g., as such) determine to apply the rate matching on the UCI bits based on the determined number of coded-modulated symbols for a UCI transmission on PUSCH.

If operating in UL resources/SBs (e.g., in SBFD slots), part of the transmission (e.g., one or more symbols (e.g., delta_N)) may be truncated, skipped, or punctured (e.g., need to be truncated, skipped, punctured) to account for the timing advance and/or switching time (e.g., the size of the difference between the time associated with the number of starting symbol(s) and the start of the guard time period). As a result, the skipped symbols may be considered in determining the number of coded-modulated symbols for UCI transmission on PUSCH.

In examples, a WTRU may determine whether to apply rate-matching or perform skipping, puncturing, or truncating on part of the transmission (e.g., on one or more symbols) to account for the timing alignment (e.g., due to timing advance and/or switching time) discrepancy (e.g., in UL resources/SBs, e.g., in an SBFD slot).

In examples, the WTRU may determine that the configured timing advance/switching time for a scheduled UL resources/SBs (e.g., in an SBFD slot) is not enough and that (e.g., delta_N) more symbols need to be considered in respective UL resources/SBs. The WTRU may (e.g., as such) start the UL transmission in advance/with delay, while skipping, puncturing, or truncating the last (delta_N) symbols at the end of the respective UL (e.g., SBFD) slot. The WTRU may determine to perform rate-matching on the coded and modulated symbols of data and control in the respective UL (e.g., SBFD) slot, while considering that the last (e.g., delta_N) symbols cannot be used for UL transmission.

In examples, the WTRU may determine to apply rate-matching (e.g., transmit the transmission in all symbols associated with the grant allocation) if the number of symbols to be skipped (e.g., the size of the time associated with the number of starting symbol(s) and the start of the guard time period) is less than a configured/determined threshold (e.g., delta_N<threshold)). In examples, the WTRU may determine to apply skipping, puncturing, or truncating to the part of the transmission that uses the grant allocation if the number of symbols to be skipped (e.g., the size of the time associated with the number of starting symbol(s) and the start of the guard time period) is more than the configured/determined threshold (e.g., delta_N>threshold). The transmission may be an UCI transmission on a PUSCH. The skipping, puncturing, or truncating of the part of the UCI transmission may be puncturing a number of coded-modulation symbols for the UCI transmission.

In examples, the WTRU may determine the number of coded-modulated symbols for the UCI to be transmitted on PUSCH, while considering the rate-matching, puncturing, skipping, truncating, and/or the like. An example of equation for determining the number of coded modulated symbols per layer for HARQ-ACK transmission on PUSCH

$$( e . g . , {\hat{Q}}_{A C K}^{′} )$$

may be provided below.

$${\hat{Q}}_{A C K}^{′} = min \{ ⌈ \frac{( {O}_{A C K} + {L}_{A C K} ) \cdot {β}_{offset}^{PUSCH} \cdot {\sum }_{l = 0}^{{N}_{s y m b , all}^{PUSCH} - 1} {M}_{s c}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{s y m b , all}^{PUSCH} - 1} {M}_{sc}^{UCI} ( l ) ⌉ - ( {M}_{symb}^{delta\_N} \times {M}_{sc}^{PUSCH} ) \}$$

where, for example,

$${M}_{symb}^{delta\_N}$$

may be the total number of symbols determined for accommodating the delta_N timing alignment discrepancy.

$${M}_{sc}^{PUSCH}$$

may be the scheduled bandwidth of the PUSCH transmission, expressed as a number of subcarriers.

Examples of forming the codeword for data and control multiplexing are provided herein. If operating in UL resources/SBs (e.g., in SBFD slots), one or more symbols (e.g., delta_N) may be truncated, skipped, or punctured (e.g., need to be truncated, skipped, or punctured) to account for the timing advance and/or switching time. As such, the WTRU may consider (e.g., need to consider) this operation as part of the procedure in forming the codeword to be transmitted on PUSCH. A WTRU may determine and/or detect timing alignment discrepancy (e.g., due to timing advance and/or switching time) in transmission of a scheduled set of UL/DL resources/SBs (e.g., in an SBFD slot). The WTRU may determine to use a procedure in incorporating the timing alignment discrepancy in respective UL/DL resources/SBs/slot. As such, the WTRU may use a procedure in mapping/forming the codeword for data and control multiplexing to be transmitted (e.g., on a PUSCH). The WTRU may perform one or more of the following. The WTRU may map the REs corresponding to one or more reference signals (e.g., DMRS, SRS, and/or the like). The WTRU may incorporate the timing alignment discrepancy into the codeword. The WTRU may map the respective (e.g., delta_N) symbols by determining to puncture, skip, or drop the symbols at the end of respective slot (e.g., UL resources/SBs in an SBFD slot). The WTRU may avoid puncturing the symbols/REs that include one or more reference signals (e.g., DMRS). The WTRU may reserve/map coded HARQ-ACK bits (e.g., if any). For example, the WTRU may reserve locations for HARQ-ACK bits if the number of HARQ-ACK bits are less than or equal to 2 bits. The WTRU may map the coded HARQ-ACK bits in the codeword if the number of HARQ-ACK bits are more than 2 bits. The WTRU may map the coded CSI part 1 first (e.g., if any), followed by mapping the coded CSI part 2 (e.g., if any). The WTRU may map the HARQ-ACK bits for which the location was reserved (e.g., as described herein). For example, if the number of HARQ-ACK bits are less than or equal to 2 bits, the WTRU may map the coded HARQ-ACK bits (e.g., if any). The WTRU may form the codeword.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), the WTRU comprising:
a processor configured to:
determine a guard time period;
receive information that indicates that a grant allocation begins at a time, wherein the grant allocation is associated with a number of starting symbols of a subband non-overlapping full duplex (SBFD) slot;
determine that the time is within the guard time period;
calculate a difference between the time and a start time of the guard time period;
determine whether to puncture a part of a transmission that uses the grant allocation, wherein the determination of whether to puncture the part of the transmission is at least based on a size of the difference between the time and the start of the guard time period; and
send the transmission.

17. The WTRU of claim 16, wherein the guard time period is associated with a number of guard symbols, and wherein the number of starting symbols is less than the number of guard symbols.

18. The WTRU of claim 16, wherein the processor is further configured to send a report that indicates the difference between the time and the start time of the guard time period.

19. The WTRU of claim 16, wherein the processor is further configured to puncture the part of the transmission that uses the grant allocation based on the size of the difference between the time and the start time of the guard time period being greater than a threshold.

20. The WTRU of claim 16, wherein the transmission is sent in all symbols associated with the grant allocation at least based on the size of the difference between the time and the start time of the guard time period being less than a threshold.

21. The WTRU of claim 20, wherein the transmission is sent in all symbols associated with the grant allocation further based on the transmission not overlapping with a higher priority signal.

22. The WTRU of claim 16, wherein the processor is further configured to receive a timing advance (TA) command, and wherein the guard time period is determined from the TA command.

23. The WTRU of claim 16, wherein the transmission is an uplink control information (UCI) transmission on a physical uplink shared channel (PUSCH), and wherein the part of the UCI transmission that is punctured includes a number of coded-modulation symbols for the UCI transmission that is punctured.

24. A method implemented within wireless transmit/receive unit (WTRU), the method comprising:
determining a guard time period;
receiving information that indicates that a grant allocation begins at a time, wherein the grant allocation is associated with a number of starting symbols of a subband non-overlapping full duplex (SBFD) slot;
determining that the time is within the guard time period;
calculating a difference between the time and a start time of the guard time period;
determining whether to puncture a part of a transmission that uses the grant allocation, wherein the determination of whether to puncture the part of the transmission is at least based on a size of the difference between the time and the start of the guard time period; and
sending the transmission.

25. The method of claim 24, wherein the guard time period is associated with a number of guard symbols, and wherein the number of starting symbols is less than the number of guard symbols.

26. The method of claim 24, further comprising sending a report indicating the difference between the time and the start time of the guard time period.

27. The method of claim 24, further comprising puncturing the part of the transmission that uses the grant allocation based on the size of the difference between the time and the start time of the guard time period being greater than a threshold.

28. The method of claim 24, wherein the transmission is sent in all symbols associated with the grant allocation at least based on the size of the difference between the time and the start time of the guard time period being less than a threshold.

29. The method of claim 28, wherein the transmission is sent in all symbols associated with the grant allocation further based on the transmission not overlapping with a higher priority signal.

30. The method of claim 24, wherein the transmission is an uplink control information (UCI) transmission on a physical uplink shared channel (PUSCH), and wherein the puncturing of the part of the UCI transmission is puncturing a number of coded-modulation symbols for the UCI transmission.
